(19) United States
(12) Patent Application Publication
(10) Pub. No.: US 2018/0144421 A1
(43) Pub. Date: May 24, 2018

(54) System and Methods for Complaint Evaluation

(71) Applicant: Velites Consulting Group, LLC, Cheney, WA (US)

(72) Inventors: Jordan Williams, Cheney, WA (US); Abigail Holman, Spokane, WA (US)

(73) Assignee: Velites Consulting Group, LLC, Cheney, WA (US)

(21) Appl. No.: 15/818,382

(22) Filed: Nov. 20, 2017

Related U.S. Application Data
(60) Provisional application No. 62/425,017, filed on Nov. 21, 2016.

(51) Int. Cl. G06Q 50/18; G06F 17/30

(52) U.S. Cl. CPC G06Q 50/18; G06F 17/30684

(57) ABSTRACT

Techniques and systems are described which provide reports including information on possible outcomes and factors to legal actions in response to receipt of a demand letter, complaint or other type of court filing. Each report is comprised of one or more sections that are units of analysis relating to the scenario of the demand letter or complaint. Each section has a contribution score, which is a weighted score that contributes to a final determination about risk associated with the demand letter or complaint. The final determination can take the form of a composite score from each of the sections in the report, giving an indication of risk associated with the demand letter or complaint. Templates are described which may correspond to different court filings, parties of interest, target audiences, and combinations thereof. Sales lead and report generation in response to the filing of certain court documents is also contemplated.

### BACKGROUND

Receiving a demand letter or summons and complaint can be frightening, especially for people and businesses with few resources and little knowledge of how the court systems work. Oftentimes, recipients of demand letters or complaints spend entirely too much time and money up front upon receipt of a demand letter or complaint, when the threat behind the demand letter or complaint is not especially serious. Other times, recipients of demand letters or complaints do not take them seriously enough, and end up with severe consequences of costly and time-consuming litigation down the road when these costs could have been avoided with proper initial action. What is needed is a way for recipients of demand letters or complaints to have a better idea of the actual threat behind the demand letter or complaint before taking action.

### SUMMARY

Techniques described herein provide reports which help inform possible outcomes and factors to patent litigation or settlements in response to receipt of a demand letter, complaint or other type of court filing. Each report is comprised of one or more sections that are self-contained units of analysis relating to the scenario of the demand letter or complaint. Each of the sections has a contribution score, which is a weighted score that contributes to a final determination about risk associated with the demand letter or complaint. The final determination can take the form of a composite score from each of the sections in the report, giving an indication of risk associated with the demand letter or complaint. Templates are described which may correspond to different court filings, parties of interest, target audiences, and combinations thereof. Sales lead and report generation in response to the filing of certain court documents is also contemplated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a better understanding of the present invention, and to show how embodiments of the same may be carried into effect, reference is made to the following figures in which:

FIG. 1 illustrates an example of a user input form for entering information relating to a demand letter.

FIG. 2 illustrates additional details of the user input form of FIG. 1.

FIG. 3 depicts an example demand letter.

FIG. 4 illustrates how information may be extracted from a demand letter.

FIG. 5 illustrates an example of a section which may be included in a demand letter forecasting report.

FIG. 6 illustrates how sections can be sized and arranged to fit within a demand letter forecasting report.

FIG. 7 illustrates examples of what may be included in a section of a demand letter forecasting report.

FIG. 8 is a flow diagram illustrating how data sources may be processed to generate a section of a demand letter forecasting report.

FIG. 9 illustrates an example overview of a demand letter forecasting report.

FIG. 10 illustrates additional details of an example overview of a demand letter forecasting report.

FIG. 11 illustrates a possible report type of a demand letter forecasting report.

FIG. 12 is a flow diagram illustrating how sections may be combined in a pre-defined order according to different report types to generate different demand letter forecasting reports.

FIG. 13 is a flow diagram illustrating how different data types can contribute to different reports based on which type of demand letter forecasting report is chosen to be generated.

FIG. 14 is an example environment which may be used to generate demand letter forecasting reports.

FIG. 15 is a flow diagram illustrating how a user may interact with a service for generating a demand letter forecasting report.

FIG. 16 is a flow diagram illustrating an additional embodiment of how a user may interact with a service for generating a demand letter forecasting report.

FIG. 17 is a flow diagram illustrating how a demand letter forecasting report may be generated.

FIG. 18 illustrates examples of metrics that may be used to describe contents of a demand letter forecasting report.

FIG. 19 depicts a rendering of a section as an additional example to the sections rendered in FIG. 5 and FIG. 6.

FIG. 20 illustrates two examples for providing a complaint or other filing to an analysis system.

FIG. 21 depicts an example of a section which may be included in a forecasting report.

FIG. 22 depicts an example of an example summary of a forecasting report.

FIG. 23 illustrates a system for generating sales leads in response to legal filings.

FIG. 24 illustrates an example set of modifications for different templates of a forecast report.

FIG. 25 illustrates a method of generating reports in response to different events.

FIG. 26 illustrates two example section templates.

FIG. 27 illustrates an auto analysis system which generates reports in response to complaints or other filings.

FIG. 28 illustrates a system for generating reports from templates specific to user types, parties of interest, and event types.

FIG. 29 depicts a procedure in an example implementation in which documents relating to a legal action are evaluated.

FIG. 30 depicts a procedure in an example implementation in which documents relating to a legal action are evaluated for an audience type.

FIG. 31 depicts example system that includes an example computing device that is representative of one or more computing systems and/or devices that may implement the various techniques for demand letter and complaint evaluation.

### DETAILED DESCRIPTION

### Non-Limiting Definitions of Various Key Terms

Demand letter forecasting report: A report that can help predict an outcome of possible patent dispute, litigation, or settlement in response to receiving a demand letter. An example is the document, “Patent Action Forecast Premier” or alternatively, “Patent Action Forecast Express.” Reports can take the form of a Word Document, PDF, rendering in a web browser, or even fields in a library from an API call, to name a few examples. Also referred to herein simply as a “report.” Reports are made up of one or more sections.

Report Type: Two example report types include “Express” and Premier.” Additional types of reports are also contemplated however. Report types have pre-defined section types and numbers of sections.

Section: Sections are units of analysis. They may have one or more determinations. They may also have input data, which undergoes an analysis process, and can be used to reach a determination. They can include visuals and/or explanations which help the user understand the determination.

Express Report: This is an example report comprising four sections: Adversary, Adversary Litigation Review, Patent Litigation Review, and Demand Letter checklist. It can make use of the following inputs: Adversary Entity Name, Adversary Legal Representation, Patent, and Demand Letter.

Graphic/Chart/Graph/Plot: Used interchangeably, but can be any visual used to present data. For example, these could be: Bar Chart, Pie Chart, Column Chart, Line Chart, Area Chart, Scatter (xy) Chart, Bubble Chart, Surface Chart, Doughnut Chart, Gas Gauge Chart, Checklist, Timeline, Flow Chart, Waterfall Chart, or Infographic.

Determination: This is the result of a section. It may be a numeric score (as in 4 out of 4), dollar amount, or term (e.g. “risky” or “Bully”), to name a few examples. Each determination may have a final score contribution amount. The final score contribution amount may or may not be shown to the user. The final score contribution amount is a weighted value that represents how much the determination of a section contributes to a final risk assessment in the report.

Rules Engine/Logic/Program/Engine/Procedurally: Used interchangeably, but generally meaning a computer program that has inputs, a set of rules/calculations, and an output(s).

NPE (Non-Practicing Entity): A company that does not provide any products or services. Also known as “patent trolls” by some commenters.

Entity/Entity Type: Capable of legal action such as companies or people. Because entity type might be of interest for strategic legal reasons, entities are divided into five types in examples provided herein: Person, Private NPE, Private Operating Company, Public NPE, Public Operating Company.

Adversary: An entity that sent a demand letter. In embodiments, a recipient of the demand letter is not in litigation yet, so the adversary may not qualify as a plaintiff, although the adversary may become a plaintiff in a patent dispute.

Lawyer: Unless otherwise stated, any reference to lawyer, lawyers, or law firm, representation will be the adversary's lawyer or law firm.

Fuzzy Matching: A fuzzy match is a process that searches and/or matches entries that are not exact but instead are scored for accuracy and/or relevancy.

Decision (law context): This is the result of a lawsuit that did not end in settlement or some transferal into a different lawsuit (e.g., Inter-district transfer or consolidation). Usually this means one side “won.” Both juries and judges can make decisions.

Breadth/Broad/Narrow (Patent Breadth): a term relating to what methods, products, or services a patent's claim “covers,” and how easy a patent is to infringe.

User Input/Form/User Data/Form Data: A user may have to input a minimum amount of data in order to generate a report. For example, aside from payment processing data, at minimum an email address to send the report to may be needed. In certain implementations, the form data can be expanded to include fields like: company name, amount at risk, etc. Gaining access to additional data may provide additional analysis options (e.g., the creation of additional sections in a report).

Demand Letter: a document (i.e., Word or PDF) that may comprise elements such as the adversary, lawyer, and patent(s) in question. A demand letter is a formal notice demanding that the entity to whom the letter is addressed perform an alleged legal obligation, such as rectifying some identified problem (e.g., patent infringement).

External Data/Data Source: This could be any data that is retrievable from an independent source. Examples include online databases/data providers like: Relecura™ Docket Navigator™, DocketBird™, and Owler™. This could also include proprietary databases/data stores like a claim text analysis database.

### Overview

In order to provide additional context for the systems and processes described herein, consider the following example scenario. Bob owns a small box factory name Bob's Box Factory. One day, Bob is served a summons and complaint for patent infringement. Bob has never heard of the company bringing the lawsuit, but has heard about “patent trolls” extorting money from small businesses such as Bob's Box Factory. Bob may have an outside attorney handle some of his contract and corporate work but does not know any patent attorneys. Bob is skeptical of attorneys in general. He looks online and finds that patent attorneys are very expensive and a case like his will cost tens of thousands of dollars. Bob is unsure if his company can sustain such an expense. Bob is uncertain about what is options are going forward, and the possible ramifications of any decision he makes. He is overwhelmed, distraught and looking for help.

Techniques described herein provide reports for persons or entities who find themselves in a situation like Bob's situation described above. A report may be provided to Bob that contains information regarding different aspects of Bob's situation in a language and format that is easy for a person who does not have legal knowledge to understand. In one or more implementations, Bob better understands his situation after reading the report and his options after receiving the summons and complaint, and Bob may decide to hire an attorney. Bob may further use the report, or a different report, to better inform his negotiations with potential attorneys. After selecting a patent attorney, Bob can send the report to his selected patent attorney to quickly apprise the selected patent attorney of the situation.

The report may include several sections that are pertinent to Bob's particular situation. For example, the report may include a Timeline Assessment section. The Timeline Assessment section provides Bob with different pieces of information regarding the average length of time to reach the conclusion of a litigation or trial for all district courts as well as the court where Bob's complaint is filed. The different pieces of information may include, in one example, a table with average durations of trials for a variety of court venues. The information on the table may come from an external data source, such as a docket monitoring service. The Timeline Assessment section may also include one or more determinations. A determination gives Bob a way to contextualize his likely timeline in view of other possible timelines, such as if his complaint were filed in a different court venue. The determination may use language or other indications, such as color schemes, that are easily understood without significant legal knowledge for users such as Bob.

The report may be generated using a number of different techniques. In one example, a docket monitoring service may be used to follow which companies have been recently served complaints for patent infringement. The docket monitoring service may provide information that Bob's Box Factory has recently been sued for patent infringement. A copy of the relevant complaint may be retrieved from the docket monitoring service and information is extracted from the complaint or other court documents. Using a variety of analytical techniques, the complaint is analyzed and the report is generated. This may include generating the Timeline Assessment section described above and including the Timeline Assessment section in the report.

The Timeline Assessment section is generated by entering data specific to Bob's complaint into a Timeline Assessment template. The data may be extracted from the complaint, data sources which analyze patents, business directories, free-form internet searches, and other data sources. The template may take the form of an excel spreadsheet, database application, or specialized software with data entry capabilities. Data may be entered manually by an analyst or automatically such as by an API. Templates may perform calculations or perform weighting on the data to produce a determination, table, graphic, or other result. Aggregate or generalized data may be used in the calculations such as the average time it takes for a court case to go to trial in all district courts in the United States. Pre-determined or analyst-generated explanations of the data, calculations, determinations, tables, and/or graphics may be rendered in the report. These explanations may utilize layman terminology and/or real-world analogies to improve understanding for people like Bob who do not have significant legal knowledge.

After receiving the report, Bob may show the report to his selected patent attorney. The patent attorney may be impressed with the analysis report, but may also desire a more thorough analysis to assist him with Bob's legal defense. The patent attorney may select a second analysis report to be generated that is designed for attorneys, but also specifically relates to Bob's patent dispute. The second report may comprise more or less sections than the first report and may comprise different versions of sections formatted for an attorney-audience. For example, both reports may contain a section about Court and Judge Analysis. Bob may only be interested in the history of final rulings of his judge. However, his attorney may be interested in the same judge's proclivity to allow certain arguments. Therefore, a first report may only contain information on final rulings whereas a second report may contain information about a judge's proclivity to allow certain arguments.

The techniques described herein provide users, such as Bob and Bob's attorney, for example, with pertinent information relating to a legal action without having to obtain, filter through, and analyze complex data from a variety of sources. Conventional systems related to legal actions required users to access multiple databases or other data sources (often having fees associated with the data sources), locate a vast array of information, narrow the information to portions relevant to their own legal action, and often required knowledge of computer coding on behalf of the user to perform at least some of the steps to gain an understanding of the legal action. On the other hand, the systems and processes described herein automatically process a relatively small number of user inputs, such as a demand letter or complaint upload, and automatically generate reports tailored to the user's legal action that are appropriate for the type of audience of the user. Accordingly, the techniques described herein provide users with a fast and accurate overview of a legal action, without requiring that the user access numerous data sources, have a background in legal knowledge or computer coding, or spend time away from other business that may be of importance to the user.

### Example Demand Letter Forecasting Report Components

A demand letter forecasting report, or “report,” may assist a recipient of a demand letter with better understanding what affects outcomes of patent litigation and predict possible outcomes of a patent litigation scenario. A report may have an overview section and any number of supplemental sections. For example, a “Premier” report may have an overview with eight accompanying detailed sections, while an “Express” report may have an overview with four accompanying abbreviated sections. In addition to the Premier and Express reports, other reports may include “Judge and Venue” reports, patent portfolio reports, or other reports on specific topics. While reports discussed herein generally relate to reports in a patent infringement scenario, it should easily be understood that the techniques described herein may be used for trademark, copyright, or other instances when a person or business receives a demand letter.

A demand letter forecasting report may include a combination of modular sections. Different combinations of sections can be mixed and matched to make different report types. In addition, the sections that make up a report may be various lengths and include different amounts of information based on a type of report that the section is included in. For example, both an Express report and a Premier report may contain an Adversary Business Assessment section. However, the Express report's Adversary Business Assessment section may contain a different and/or less extensive explanation than the Adversary Business Assessment section associated with a Premier report. Additionally or alternatively, the Express report may contain a different graphic or no graphic than the Premier version of the same section. Express reports may contain generally abbreviated sections when compared to corresponding sections contained in a Premier report.

Each report may have an Overview section, including a composite score which is a combination of the scores from each of the sections in the report. The sections can be weighted by how important they are to determining risk associated with the demand letter, dispute, or situation. The Overview may have a graphic to show a risk level of associated with receiving the particular demand letter. For example, the graphic may have four risk level ranges: low, medium, high and highest. Each risk level may be represented by a color. The risk level is determined based on a composite score of each of the sections making up the report, and the composite score is compared to a numeric range for each of the risk level ranges to determine which range it belongs in. A paragraph in plain language may be included in the overview section that gives a description of each of the sections included in the report.

There may be different scoring calculations for different types of reports. For example, an Express report may be out of 15 points, whereas a Premier report may be out of 45 points. The scoring may be additive; however, other techniques for scoring are contemplated. Some sections may increase the overall score by a multiplier, logarithm, power, or division, or something else. There may be a type of report where the score isn't an arbitrary number but instead is a dollar amount, such as a cost prediction, for example.

Sections of a report can be thought of as self-contained units of analysis. A section of a report may include:
At least one Determination. A determination is the result of the analysis for a particular section. An example of a determination is “Bully.” Other examples of determinations are “Highly Competent” or “Moderately Aggressive.” Other example determinations are contemplated, several examples of which are discussed below. Determinations may also be inconclusive, such as if not enough information is provided to make a conclusive determination.
A Contribution Score. A contribution score is a number of points that a particular section adds to the final score of the report. The contribution score relates to the determination for the section. One example of a determination is “high likelihood of validity.” This particular determination may make the score for the particular section contribute 6 out of 6 possible points to the final score.
Explanation of the Section. An explanation of the section provides some description about what the section means and why it is important. The explanation of the section may be in plain language that assists the recipient of the demand letter in understanding the section.
Explanation of the Section Outcome. An explanation of the section outcome provides a plain language description about what the determination means for the user's dispute.

The sections may include boiler plate descriptions, which may be adjusted for each unique case, such as by a human evaluator. Alternatively or additionally, this process may be automated. The boiler-plate descriptions of the sections may comprise the “Description of the Section” and “Description of the Section Outcome” portions of the sections. A rules engine may generate and/or modify sentences based on input data and/or external data. For example, when a section has a high contribution score, that section may include different wording than when the same section has a low contribution score, which will again be different than when the section has missing information that contributes to the contribution score for the section. The boiler plate descriptions may also be affected by which other sections are present in the report, and refer to other sections that are present in the report.

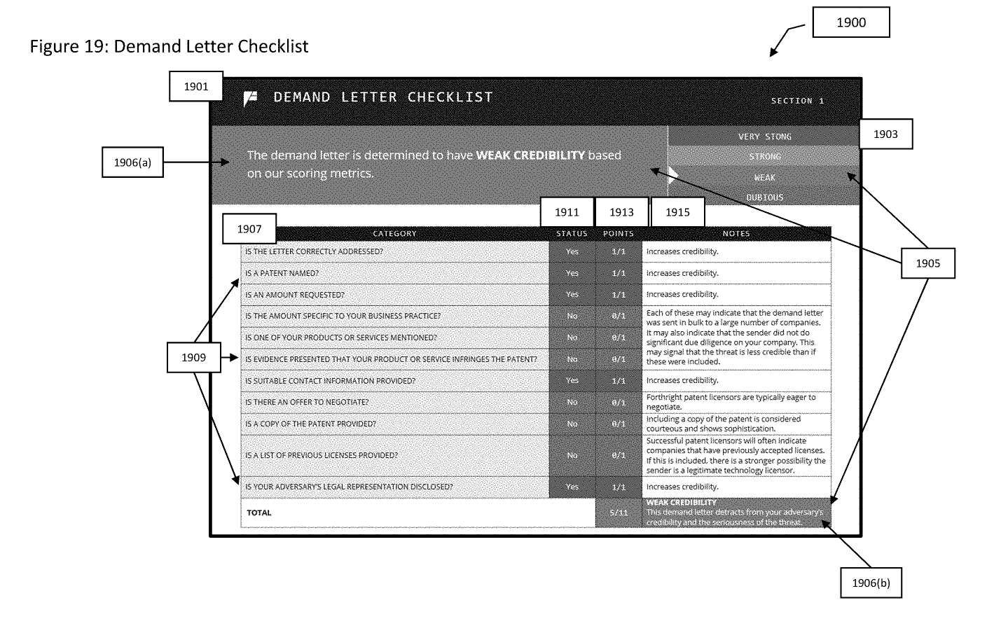

Sections may also have tables, which may outline how a determination was reached. An example of this is a demand letter checklist 1901 shown in FIG. 19. Tables may also present information to the recipient that may not necessarily contribute to the determination, but may be useful for other reasons. An example of this is an Entity Type table, which simply displays information relating to different types of entities for the report recipient's knowledge.

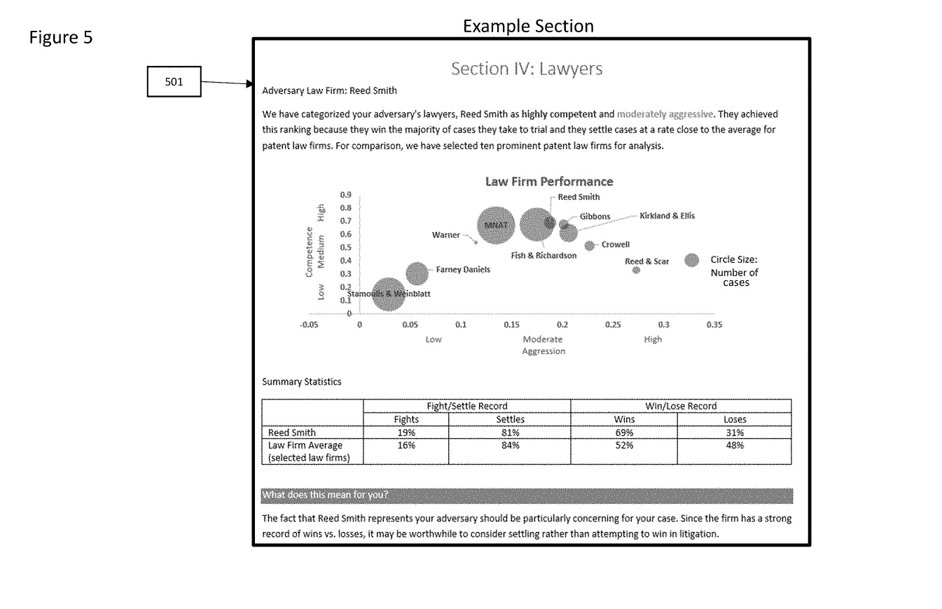

Sections may further include graphs illustrating ways that data was used to reach the determination for that particular section. An example is a Law Firm Performance graph 501 shown in FIG. 5. The generation of tables and graphs for sections may be done by a human, or may be automated.

Two different types of reports are discussed herein as examples—“Express” reports and “Premier” reports. The Premier report may have more sections (8 sections for Premier vs. 4 sections for Express). The Premier report may also include sections which are similar to the Express report but are more in-depth. Both reports may have an Overview and risk score.

The following are examples of possible sections which may be included in a report:

Adversary Business Assessment.

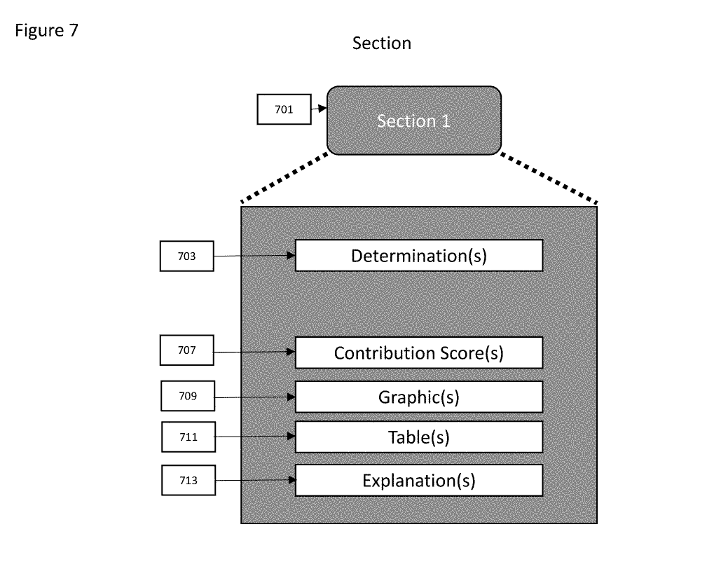

An Adversary Business Assessment analysis may manifest as a section 701 shown in FIG. 7. Possible determinations for this section may include the following types of adversary businesses, and have corresponding scores associated with each: Public Operating Company, Public NPE, Private Operating Company, Private NPE, and Individual Person, for example. Data Sources for obtaining information on the adversary's business may include business directory and database services such as Owler™, which can be used to determine if adversary business is public or private, and/or for gathering information on whether the adversary's business is an NPE. For example, the adversary's business can be searched on Owler™, such as by querying a database. Information obtained from the database may be passed through a rules engine to determine a type of business of the adversary. If the Adversary's Business is determined to be a person, then an indication of the Adversary's Business being a person is entered into the Adversary Business Assessmentsection of the report. If the Adversary's Business is listed on a stock exchange, it is determined to be a public entity and an indication of the Adversary's Business being a public entity is entered into the Adversary Business Assessment section of the report as public. If the Adversary's Business is not listed on a stock exchange, the Adversary's Business can be entered as private. If a product or service of the Adversary's Business cannot be found, or if there is evidence they are an NPE, the Adversary's Business can be determined to be an NPE, and NPE is entered into the Adversary Business Assessment section of the report.

The Adversary Business Assessment section may also include a graph or flow chart generally depicting the methodology decision points in making the determination of the Adversary's business type, and may include some description of the determination. Further, the Adversary Business Assessment section may include a table describing each determination category, and may include a plain language description of how the determination made in the Adversary Business Assessment section might affect litigation following the demand letter.

Generating the Adversary Business Assessment section may include fuzzy matching names of businesses. For example, court data and financial data rarely match—court documents might say Google Inc., whereas the financial data is listed under Google Corp. or Alphabet Inc. The fuzzy matching can be uniquely tuned to alter existing fuzzy matching algorithms for use in generating the Adversary Business Assessment section.

Implementations may also consider and display other information than just entity type. This may include drawing revenue data, names of inside counsel, names of executives, ownership structures, profit and loss, and other various business metrics. This additional information may be obtained from more than one data source. Additionally, certain data sources may only be queried if one or more conditions are met. For example, if it is determined that the adversary is a person, there may be no point in looking up revenue information.

Adversary Legal Assessment.

An Adversary Legal Assessment analysis may also manifest as a section 701. Possible determinations for this section may include types of legal representation for the adversary, and may have corresponding scores associated with each type of legal representation. In one example, there are four possible categories of determinations for an Adversary Legal Assessment: Pacifist (0 points), Godfather (3 points), Bully (2 points), Brawler (4 points). Types of legal representation indicated herein and the associated scores are intended only as examples, and are not intended to be limiting. Example data sources for obtaining information on the adversary's legal representation may include patent search and analysis database services such as Relecura, which may indicate a number of the adversary's granted patents. Another example data source for obtaining information on the adversary's legal representation may include a searchable research database service such as Docket Navigator™, which may indicate a number of the adversary's lawsuits as plaintiff, a number of lawsuits settled as a plaintiff, and/or a number of lawsuits taken to decision as a plaintiff.

An x-y plot indicating “Plaintiff Temperament” may be included in the Adversary Legal Assessment section, where the x axis measures aggression. The calculation for this metric can be computed by log(lawsuits filed/patents owned). This computation represents some entities having a lot of patents but mainly for defensive purposes, which results in “low” aggression. Other entities initiate a lot of litigation for every patent they own. An aggressive example of an entity that initiates a large number of litigations per patent is a “patent troll” that owns one patent (or an otherwise small number of patents) and initiates legal action frequently. The y axis measures compromise. The calculation for this metric can be computed by (lawsuits filed)/(lawsuits settled). This computation represents entities that will file a suit but back down most of the time, whereas other entities may tend to push through to a decision. The Plaintiff Temperament plot can be broken up into quadrants each with a characterization, and show interactions between compromise and aggression.

This description of a possible Plaintiff Temperament plot is intended only as an example. Other calculations may be used to plot aggression and compromise. Alternatively or additionally, additional axes may be included. For example, circle size may be used to indicate a number of lawsuits by the adversary, or the adversary's legal representation. The circle size may be adjusted with a decay function, so lawsuits from 1980 do not have as much effect as ones from a more recent year, for example. A nearest neighbor algorithm may also be used to select a “most similar” company to the adversary in terms of temperament. This may assist in the scenarios where there is little litigation history for the adversary. Additionally, a k-nearest neighbor algorithm may be used to find pockets of similar-temperament entities.

Additionally, a litigation bandwidth metric may be employed in the Adversary Legal Assessment section. The litigation bandwidth metric can measure how much and/or how many litigations an adversary might be able to handle at a given time. The litigation bandwidth metric may be a function of revenue, legal budget, number of lawyers, most lawsuits at a given time in the past or other possible inputs. The litigation bandwidth metric may be plotted alongside the compromise metric, for example, to see if there is a point where an entity starts settling because they are overworked in litigation.

Further, the Adversary Legal Assessment section may include a competency metric, indicating how often an entity wins or loses. Once again this may be plotted alongside one or more of the other metrics to present insights.

Lawyer Assessment.

A Lawyer Assessment analysis may additionally manifest as a section 701. One possible determination for the Lawyer Assessment section may include determinations of the following categorizations of competence of the adversary, and have corresponding scores associated with each: Unknown competence, Questionable Competence, Average Competence, High Competence. An additional possible determination for the Lawyer Assessment section may include the following categorizations of aggression of the adversary, and have corresponding scores associated with each: Low aggression, moderate aggression, high aggression. These categorizations and any associated scores are intended only as examples and are not intended to be limiting. Data sources for obtaining information on the adversary's legal representation may include a searchable research database service such as Docket Navigator, which may indicate a number of lawsuits settled, a number of lawsuits taken to decision, a number of lawsuits with favorable outcome for a client, and/or a number of lawsuits with unfavorable outcome for a client.

A bubble chart may be used to plot law firm performance for the Lawyer Assessment section. In this example, the x axis measures aggression of the adversary. Aggression of the adversary is calculated as (number of cases brought to decision)/(total cases) for each law firm or lawyer. The y axis in this example measures competence of the adversary. Competence of the adversary is calculated as (number of cases with a favorable outcome)/(total cases) for each law firm or lawyer. The circle size represents a total number of cases for each law firm or lawyer. A decay function may be used to generate circle size so that more recent cases have a larger influence on a size of the circle. The circle representing the adversary may be plotted along with a number of other law firms for comparison.

A number of cases by the particular legal entity representing the adversary may be part of the Lawyer Assessment section. The number of cases by the particular legal entity representing the adversary may be affected by a decay function. Alternatively or additionally, a bandwidth metric may be used to represent the number of cases by the particular legal entity representing the adversary, similar to the discussion of the Adversary Legal Assessment section. Specific inputs for a bandwidth metric may be included on partners and associates in law firms, number of ongoing cases, etc. Further, a metric may be used relating to case complexity, and each law firm or attorney has an associated complexity threshold. For example, if the law firm or attorney has too many complex cases at one time, their performance might be in question, thus affecting the score of the case complexity metric. Other distinctions may be made, including distinctions between boutique and general practice law firms, for example. Additionally, similar and supplementary analyses can be applied to individual lawyers. For instance, individual lawyer movement may be tracked, so that if a lawyer who is proficient in litigation changes law firms, the new law firm (and the previous law firm) will have metrics altered accordingly. In addition, further metrics may be used, such as fee structure or fee amount for a law firm or individual lawyer.

Patent Assessment.

A Patent Assessment analysis may manifest as a section 701. One possible determination for the Patent Assessment section may include the following categorizations of validity of the patent(s) being asserted in the demand letter, and have corresponding scores associated with each: Likely Invalid, Questionable Validity, Inconclusive Validity, Likely Valid, High Likelihood of Validity. An additional possible determination for the Patent Assessment section may include the following categorizations of breadth of the patent being asserted in the demand letter, and have corresponding scores associated with each: Very Narrow, Narrow, Broad, Very Broad. These categorizations and any associated scores are intended only as examples and are not intended to be limiting. Data sources for obtaining information on the patent being asserted in the demand letter may include patent search and analysis database services such as Relecura™ or IP Street™ which may be used to determine patent term (including whether the patent is expired), whether the fees have been paid, if the patent asserted in the demand letter is a reissue patent, and/or a backward citation count, to name some examples. Data sources for obtaining information on the patent being asserted in the demand letter may further include a searchable research database service such as Docket Navigator™ which may be used to determine whether the patent asserted in the demand letter has been tried in court, validity findings on the patent asserted in the demand letter, and/or PTAB results of the patent asserted in the demand letter. Alternatively or additionally, internal databases that include information on the patent being asserted in the demand letter may be used to determine claim text of the patent asserted in the demand letter, for instance.

A Validity Flowchart may be used with available data on the patent asserted in the demand letter to determine likely validity of the patent asserted in the demand letter. The Validity Flowchart may ask a series of questions which eventually lead to one of several possible validity determinations. The path for this particular patent may be visually indicated on the Validity Flowchart so users can discern how the patent got to the particular determination.

A Breadth Score(s) may be determined for the patent(s) asserted in the demand letter. A waterfall chart may be used to determine the breadth of the patent's claims and thus the Breadth Score. The waterfall chart includes different features of a patent as well as different events that have happened to the patent during the patent's lifetime that affect the patent's breadth score. For example, infringement and licensing events may increase the score, findings of non-infringement may decrease the score. A database of claims found infringed in court may also be used to compare to the patent asserted in the demand letter in order to determine the Breadth Score. For example, more claims in a patent may improve odds of infringement, as well as shorter independent claims. The patent asserted in the demand letter is compared to a target number of claims and a target claim length, and these comparisons are used to contribute to the Breadth Score.

Additional components which can be included in the Patent Analysis section may include:
Analysis in view of precedential court decisions. One illustrative example may be an ALICE validity component. In an Alice validity component, a determination is made as to whether the patent is in an art unit or patent class (e.g. US/705) that frequently may be applicable to the Alice Corp. v. CLS Bank International ruling. Analysis in view of precedential court decisions may take into consideration the date of the ruling compared to the application date, priority date, or grant date associated with a patent(s). Additionally or alternatively, certain words or word combinations may be analyzed which may be affected by certain rulings. In one example, “computer-readable media” may not be patentable under 35 U.S.C. section 101 because it can be interpreted as a signal or carrier wave. The USPTO has suggested amending claims to recite “non-transitory computer-readable media.” Therefore, a patent that includes a claim with the term “computer-readable media” may negatively affect an analysis in view of precedential court decisions.
Drafting law firm, lawyer, or agent, and evaluation of that firm, lawyer, or agent. Evaluation of a drafting firm, lawyer, or agent can be done using techniques similar to those described above in the “Lawyer Assessment” section, although additional and/or different metrics may be used than the metrics used to analyze the litigation aspects of the “Lawyer Assessment” section. For example, a firm that specializes in patent prosecution may be assessed on “claim preservation” or how many dependent claims are lost during prosecution. Another metric by which a firm or lawyer may be assessed is allowance rate per number of applications prosecuted by that firm or lawyer. Other metrics which may involve word choice, maintenance fee payment, or litigation success are also contemplated.
Inventor(s) evaluation. Evaluation of the number of inventors may affect aspects of the patent's validity, for example. Further, specific inventors may be tracked, as certain inventor's patents may do better in litigation than patents by another inventor.
Claim text analysis. Claim text analysis may include word count of the claim; shortest independent claim word count; word count of the claim with stop words filtered out; unique term count of the claim; reading level or vocabulary level of the claim; longest word in the claim; average word length in the claim; ratio of independent to dependent claims; poor word choice in the claim (e.g., “must”); element count (also referred to as claim limitations or where paragraph breaks or semi-colons occur in a patent claim); difference between final and original claim text (e.g., how the claim was altered during prosecution, or whether the claim significantly narrowed during prosecution).
Class analysis. A U.S. or international patent class may be assigned to a patent. Certain classes may have a better track record in litigation or licensing than other classes. Inferences can be made about a patent based on the patent class it belongs to. Additionally, certain patents may belong to more than one class. The number of classes and/or the combination of classes may be subject to analysis. For example, a patent assigned to 5 patent classes may be considered broader than a patent assigned to 2 patent classes.
Citation analysis. This may relate to patents or non-patent documents that were cited during prosecution of a patent (e.g., backward citations), and/or patents that have cited the patent in prosecution (e.g., forward citations). Any suitable types of analysis on both backward and forward patent citations may be used in citation analysis. For example, patents with many forward citations are sometimes considered to be more valuable than patents with few forward citations. Additionally, a patent with many backward citations may have a higher likelihood of validity than a patent with fewer backward citations.
Analysis of patent ownership. For example, a patent that has changed owners several times may have more value, and might have a higher likelihood of being valid. Patents may be encumbered or owned by more than one party, which may complicate litigation.
Patent portfolio analysis. Multiple patents may overlap to create a patent thicket. A patent thicket may have a higher success rate in litigation or licensing than a single patent. Conceptually similar patents or patents belonging to the same patent family may be considered. Additionally, pending applications which are related to a patent may considered.

Sometimes, there may not be an actual patent specified in the demand letter. The lack of a patent specified in the demand letter may cause information in the Patent Analysis section to be sparse. However, in these circumstances, further investigation may be done to determine the patent being asserted. For example, the entity that sent the demand letter may be investigated, and their products or patents in which they are listed as the assignee can be analyzed to determine which patent the entity is asserting. If the entity only owns one patent, the patent owned by the entity can be used for analysis in the Patent Analysis section, and publicly-available data relating to the patent can be used to generate the Patent Analysis section.

Court & Judge Assessment.

A Court & Judge Assessment analysis may also manifest as a section 701. A possible determination for this section may include the following categorizations of jurisdiction, venue, and decision maker of a court, and have corresponding scores associated with each. For instance, each of the jurisdiction, venue, and decision maker of a court may have a categorization such as Plaintiff Friendly, Balanced, and Defendant Friendly, with each categorization having an associated score. Categorizations and any associated scores for the Court and Judge Assessment section are intended only as examples and are not intended to be limiting. Data sources for obtaining information on the jurisdiction, venue, and decision maker of a court may include a searchable research database service such as Docket Navigator™ to identify information such as a number of cases found in favor of plaintiff/defendant and a number of cases taken by each judge.

A visual may be provided in the Court and Judge Assessment section, such as a pie chart for case results in the particular venue. The pie chart may comprise a number of cases where the plaintiff won, a number of cases where the case was settled out of court, and a number of cases where the defendant won, where the number of cases in each category is represented by a percentage of the pie chart. In addition, another pie chart may be included in the Court and Judge Assessment section with the national averages for the same categories for a visual comparison to the pie chart for the particular venue. A comparison may be made between the national percentage of the number of cases where the plaintiff won to the percentage of the number of cases the plaintiff won in the particular venue. A similar comparison can be made between the national percentage of the number of cases where the defendant won to the percentage of the number of cases the defendant won in the particular venue. These two comparisons can be used to make a determination on whether the particular venue is plaintiff-friendly or defendant-friendly. Other methods of determining whether the particular venue is plaintiff-friendly or defendant-friendly are also considered. Further, other techniques for displaying information in the Court and Judge Assessment section is contemplated, such as a chart that plots whether the venue is plaintiff-friendly or defendant-friendly on one axis, and the number of cases settled to the number of cases taken to decision on a second axis. Additionally, the percentage of settlements may be left in the pie charts as a visual to indicate how often cases are settled.

Similarly, an additional visual may be provided in the Court and Judge Assessment section that provides analyses for a judge presiding over a case, or the jurisdiction in which the case is to be tried or likely to be tried. In one example, when evaluating a particular judge, a pie chart can be provided with the cases the particular judge has tried in the past two years, and include determination percentages for the plaintiff and the defendant. Other characteristics of particular judges can also be evaluated and displayed in various formats in the Court and Judge Assessment section, including summary judgment likelihood, which arguments are accepted and which arguments are not accepted, whether the judge typically sides with larger entities or smaller entities, or whether the judge awards treble damages, to name some examples. Additional metrics may be provided on judges over time as well, such as how a particular judge's rulings have changed over time. Factors may be considered for when making evaluations on particular judges, such as how many cases a judge has tried. For example, a judge who has tried fewer cases may result in a judge being less predictable, and an experienced judge may be more capable of handling more complex litigation.

Additional sections may be provided in the Court and Judge Assessment section, including a Patent Trial and Appeal Board (PTAB) evaluation and accompanying visuals, and/or an International Trade Commission (ITC) evaluation and accompanying visuals. For example, when a recipient of a demand letter requests a report, they may be asked to provide information on whether the product is imported into the United States. In this case, the Court and Judge Assessment section could be replaced or supplemented with an ITC Assessment section. Alternatively or additionally, information on juries can be included in the Court and Judge Assessment section. The information on juries may include how often juries find for validity, infringement, or treble damages, to name some examples. Juries may further be evaluated on jurisdiction and/or venue to determine if certain jurisdictions or venues fare better than others for plaintiffs or defendants.

Timeline Assessment.

A Timeline Assessment analysis may manifest as a section 701. A possible determination for this section may include categorizations of a timeline to a resolution with an adversary who sent a demand letter. The categorizations of the timeline may include Longer, Average, and Shorter, and have corresponding scores associated with each. These categorizations and any associated scores are intended only as examples and are not intended to be limiting. Data sources for obtaining information on the timeline may include a searchable research database service such as Docket Navigator™ for information on filing dates, trial dates, termination dates, and other event dates.

Because it may be uncommon for a jurisdiction or venue to be determined at the time of receipt of the demand letter, one or more of the three most common jurisdiction/venue combinations may be selected for evaluation in the Timeline Assessment section. These may include the Central District of California, the District of Delaware, and the Eastern District of Texas, although other jurisdictions and venues are contemplated. Alternatively, certain rules may be implemented to determine a most likely jurisdiction. For example, if the plaintiff already has cases pending in a jurisdiction and venue, then this jurisdiction and venue can be selected. However, if the plaintiff does not have any current or previous cases in any jurisdiction or venue, a jurisdiction and venue where attorneys named in the case typically litigate can be selected. If no indication of a jurisdiction or venue can be found relating to the plaintiff or the plaintiff's attorneys, then a default jurisdiction and venue can be selected, such as the Eastern District of Texas for example. Once a jurisdiction and venue is selected, timeline information can be provided in the Timeline Assessment section relating to that particular jurisdiction and venue. Other factors that may affect the timeline information may include the type of plaintiff. For example, an NPE may cause a more accelerated timeline to be displayed in the Timeline Assessment section than two operating corporations who co-own the patent asserted in the demand letter.

Cost Projection Assessment.

A Cost Projection Assessment analysis may manifest as a section 701. When a demand letter or other request is received to generate a report, it is possible that very little information is provided about the recipient of the demand letter. In this case, generalized determinations can be provided to give the recipient an idea of cost projection associated with defending a product or service accused on infringement in the demand letter through trial. A possible determination for this section may include the following categorizations of cost projection: $2 million or $1 million. These categorizations are intended only as examples and are not intended to be limiting. Data sources for obtaining information on cost projections may include business directory and database service such as Owler™ for information on whether the entity that sent the demand letter is an NPE or other type of entity. Data from other sources, such as cost projections for litigation may be accessed from sources such as the American Intellectual Property Institute, or other data source.

With more user inputs relating to the recipient of the demand letter, additional information can be provided in the Cost Projection Assessment section. For example, a form may be provided to the recipient of the demand letter in which information can be provided about the amount of money the recipient of the demand letter has at risk, which would better inform potential litigation costs. Additionally, information may be provided in the Cost Projection Assessment section as a “cost by milestones” visual, which would indicate average costs through certain milestones of litigation such as discovery, Markman hearings, or summary judgment motions, to name a few examples. This may be depicted as a timeline, so that the recipient of the demand letter can plan on how much money they will need to have available at certain times in the future. This view may also indicate additional information, such as settlement costs increasing as the parties move through litigation. Further, if a specific amount is stated in the demand letter, this may be provided in the Cost Projection Assessment, such as in a visual manner that a reader can compare to potential litigation costs. Potential costs may also be broken down into different fees, such as discovery fees, attorney's fees, or expert witness fees, to name some examples.

Demand Letter Analysis.

A Demand Letter Assessment analysis may manifest as a section 701. A possible determination for this section may include the categorization of the demand letter as having Strong Credibility, Moderate Credibility, or Weak Credibility. This categorization are intended only as examples and are not intended to be limiting. Data sources for obtaining information on the demand letter and typical demand letter features may include various information provided by the demand letter recipient, internal data gathered on demand letters, or sources which aggregate demand letters such as TrollingEffects.org.

A checklist visual may be provided in the Demand Letter Analysis section with typical demand letter features, and indications of which features a particular demand letter does and does not have. The particular demand letter can be awarded points based on the features that are present, for example, 1 point for each of the features that are present. Alternatively, features can be awarded different point values, including different features having different point values on the same demand letter checklist, or points being subtracted (or negative-valued features) when features are missing from the particular demand letter. For example, features may have a multiplicative or power effect, or a variable effect. In one example of a variable effect, a number of licenses of the patent asserted in the demand letter could variate the score for a feature relating to “licenses.” Further, indications can be provided on the checklist on whether a particular feature increases credibility of the demand letter, for example. The points of the particular demand letter can be totaled for a credibility score of the particular demand letter. For example, if the particular demand letter obtains a score of 0-5, it can receive a “Weak Credibility” designation, a score of 6-10 receives a “Moderate Credibility” designation, and a score higher than 10 receives a “Strong Credibility” designation. These score ranges and designations are intended only as examples.

While “credibility” is described in the above example as a designation for the particular demand letter, other designation classifications are also contemplated. For example, a demand letter may be classified based on professionalism and/or personalization to the recipient. Any or all of these classifications and/or designations may be plotted on one, or multiple, graphs or charts and provided in the Demand Letter Analysis section. Further, the particular demand letter may be compared to other demand letters, such as an “ideal” or “typical” demand letter or letters, such as for each designation or classification. In addition, demand letters may be correlated with litigation or settlement outcomes of a particular demand letter. In this scenario, a requestor of a report may be provided with a Demand Letter Analysis section that displays the demand letter received to another demand letter from the same entity that is retrieved from a database of demand letters. An indication may be provided that the entity who sent the demand letter never actually commenced litigation, and that the entity was reprimanded for sending spurious demand letters. In this case, the recipient of the demand letter may choose to ignore the demand letter or report the sender. Alternatively, an indication may be provided that the entity who sent the demand letter sue frequently, and typically win in court. In this example, the recipient of the demand letter may wish to seek further legal assistance with the demand letter.

Additionally, particular demand letters may be compared to demand letter laws for the state in which the demand letter was received to determine if the demand letter meets the requirements for the laws of that state. This may also give an indication as to whether the demand letter has sufficient credibility, be used to categorize the demand letter as described above, or used to provide an indication as to whether the demand letter is legally fitting for the recipient's location, for instance.

Litigation Activity Assessment.

A Litigation Activity Assessment analysis may also manifest as a section 701. This section may provide information on how often patent litigation occurs in a technology area (which may be determined patent class, art unit or conceptual similarity, to name a few examples), and how predictable determinations are in the technology area. The Litigation Activity Assessment section may use information such as patent class or art unit, and information from a searchable research database service such as Docket Navigator™. A number of litigations for the class or art unit can be analyzed, and/or a number of litigations versus a number of patents in the class or art unit, to make determinations for the Litigation Activity Assessment section. The information provided in the Litigation Activity Assessment section may utilize a variety of different decay functions to account for time in the technology area, as different technology areas expand at different rates. Other illustrative technology areas may also be compared to the technology area of the patent asserted in the demand letter.

Having considered possible components of a demand letter forecasting report, consider now possible implementations of processes for requesting, generating, and receiving demand letter forecasting reports.

### Example Procedures for Requesting, Generating, and Receiving Demand Letter Forecasting Reports

In a first example process, a user visits a website or application that is configured to generate and display demand letter forecasting reports. The user may select a report from a variety of different reports that the user would like to have generated. The user fills out a form that includes information necessary to deliver a finished report. The user then uploads a demand letter, and/or inputs information from a demand letter they have received. Next, the user provides payment for the report. The report is generated from the information and the demand letter, and the user receives a report document, such as at an email address that the user provided. Alternatively, the user may be notified that the report is ready to be accessed at the website or application, such as by logging in with a username/password combination.

In another example, a user visits a website or application that is configured to generate and display demand letter forecasting reports. The user fills out an electronic form on the website or application that may include fields to enter information in response to questions such as “How much is at risk in this dispute?” and “Have you already responded to the demand letter?” The user may also submit the demand letter, or enter information from the demand letter. A system then evaluates the demand letter or information entered from the demand letter looking for components such as adversary name, adversary lawyer or law firm, and amount demanded, to name some examples. The system also evaluates the information received in the electronic form. The evaluations take place in real time by one or more computing devices, or are performed shortly after the demand letter and electronic form are submitted.

Next, as a result of data available from the demand letter and the electronic form, the system may present a variety of report generation options. If a certain type of report requires a particular piece of information, and that particular piece of information has not been provided, the type of report requiring that information may be withheld from selection, such as by “greying out,” or the user may be requested to input the particular information if they wish to have that report generated. For example, the user may be able to hover over a greyed-out report option to see missing data that is required to enable the report as an option. When the user selects a valid report option to generate that report, they are directed through payment processing for the report. The report is then generated and sent to an email address provided by the user, available for viewing on the website or application, or available via other export options.

In another example process, a system comprising a web site or application verifies that a report type has been selected, a form (electronic or otherwise) having additional necessary information has been submitted, a demand letter or information from a demand letter uploaded or otherwise provided, and payment is confirmed. Form inputs and demand letter information are entered into a spreadsheet that comprises data entry components for the report type that was selected. The spreadsheet updates charts and calculations, and may use a system such as Mail Merge to update a document template for the selected report type and generate the report. The report may be read through for errors, and the spreadsheet may be updated to correct for errors that may occur in the future. The generated report is then provided to an entity that requested the report, such as by email or at the website or application.

In yet another example process, a system comprising a website or application facilitates a user to input form data and upload a demand letter or input information from a demand letter. The form data and data obtained from the demand letter are combined and analyzed according to a predefined logic to determine which report types may be generated from the combined data. The determined report types are presented to the user, which may include displaying additional report types that may need more information than has already been provided as discussed above. The user may select one of the report types. Alternatively or additionally, the user may select report sections in an “a la carte” fashion to design their own customized report. Each of the report sections may have an associated price to be included in a customized report. In addition, templates may be provided with a predetermined number of sections, in which a user may insert desired sections to be included in the customized template for a report. In this scenario, the customized template may have a set price, regardless of which sections are chosen by a user to be included in the report, such as 5 selected sections having a set price, 2 selected sections having a set price, or 10 selected sections having a set price, for example. Based on the user's selection(s), the user is prompted through payment processing for the selected report.

The combined form data and data obtained from the demand letter populate a series of queries. The series of queries may be further specified by the report type or the selected sections of the report, and used to query various external data sources. The queries return external data. Based on the returned external data, the combined form data and data obtained from the demand letter, and the report type or selected sections of the report, a report template instance is created and populated. Various programmatic operations may affect, combine, compare, and/or transform the returned external data and the combined form data and data obtained from the demand letter before it is populated into the template. The report template instance may be stored in a database for further meta-analysis. When the template instance is finished, it may be proof-read by an analyst or proof-reading algorithm.

The finished template instance is provided to a user, such as via email as a PDF document, in the website or application, or both, to name some examples. Alternatively or additionally, results provided in the finished template instance may be a machine-readable output that a user may access via an API. Additionally, a feedback mechanism may be implemented to receive feedback on the report. For example, a user may be prompted to fill out a feedback form after receiving the report giving impressions and reactions to the report. Information received from the feedback form may be stored for meta-analysis. Results of several meta-analyses may be used as data input on subsequent reports. For example, statistics on various determinations may be provided to users based on the results of meta-analyses, such as a percentage of the total reports generated that receive a “High Risk” designation.

Having considered example procedures for requesting, generating, and receiving demand letter forecasting reports, consider now an example environment for generating forecasting reports.

### Example Environment for Generating Forecasting Reports

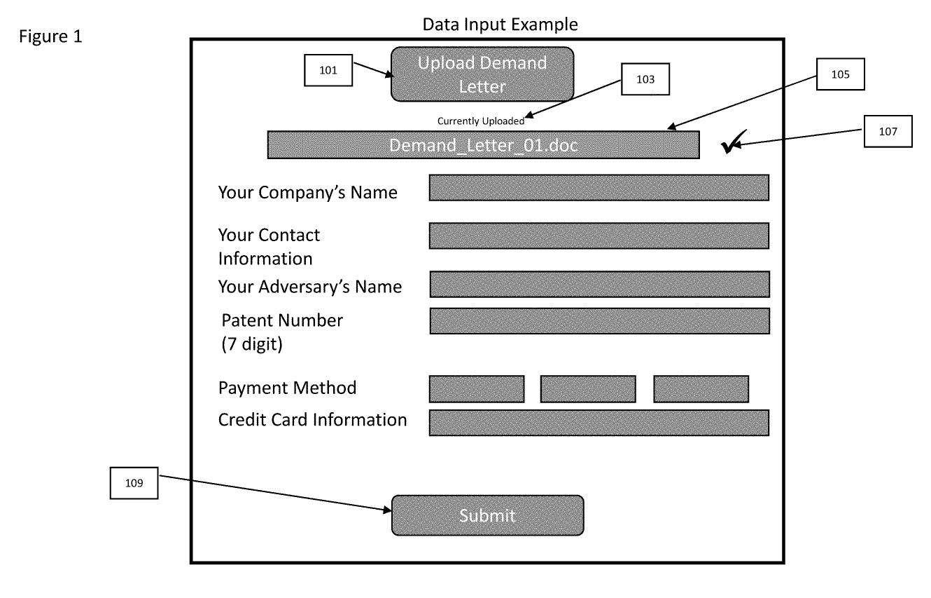

FIG. 1 generally depicts an example of a user interface comprising a user input form that may be displayed as part of a website or application that is configured to implement demand letter forecasting in accordance with one or more implementations. An upload demand letter button 101 is pictured which is configured, when selected, to provide a user with an interface to upload a demand letter. After selection of the upload demand letter button 101, a user may navigate to where a demand letter is stored, such as on their computer or hard drive, and select the demand letter to be uploaded. The demand letter may be a word document or PDF, for example, but other formats are also considered, such as txt documents or JPEG images.

The user interface also includes an upload status indicator 103 which indicates if a demand letter has been successfully uploaded. Initially, the upload status indicator 103 may comprise an indication such as “No demand letter uploaded” and, when a document is successfully uploaded, change the indication to “Currently uploaded,” for example.

The user interface further comprises an upload document name 105, which displays the name of the document that has been uploaded. Various indications may be used to display that a document has been successfully uploaded, such as displaying the name of the uploaded document, changing color, or a notification such as “Upload Successful!” for example. The upload document name 105 may change color, such as to red, if the document was unsuccessful, or if a user attempts to submit the user input form without uploading a document.

A success icon 107 may be provided in the user interface which indicates that a field was submitted successfully. For example, if a document is uploaded successfully, a green check mark may appear as the success icon 107. The success icon 107 may assist in leading a user through the user input form and ensure that all necessary fields are completed.

The user interface further comprises a submit button 109 which finalizes the user input form and allows form data to enter an internal system for processing. The submit button may be greyed out and/or unselectable if the required fields of the user input form are not completed. Alternatively, they system could return another form window or the same window with unfilled-but-required fields highlighted with an indication such as “please fill out required fields.”

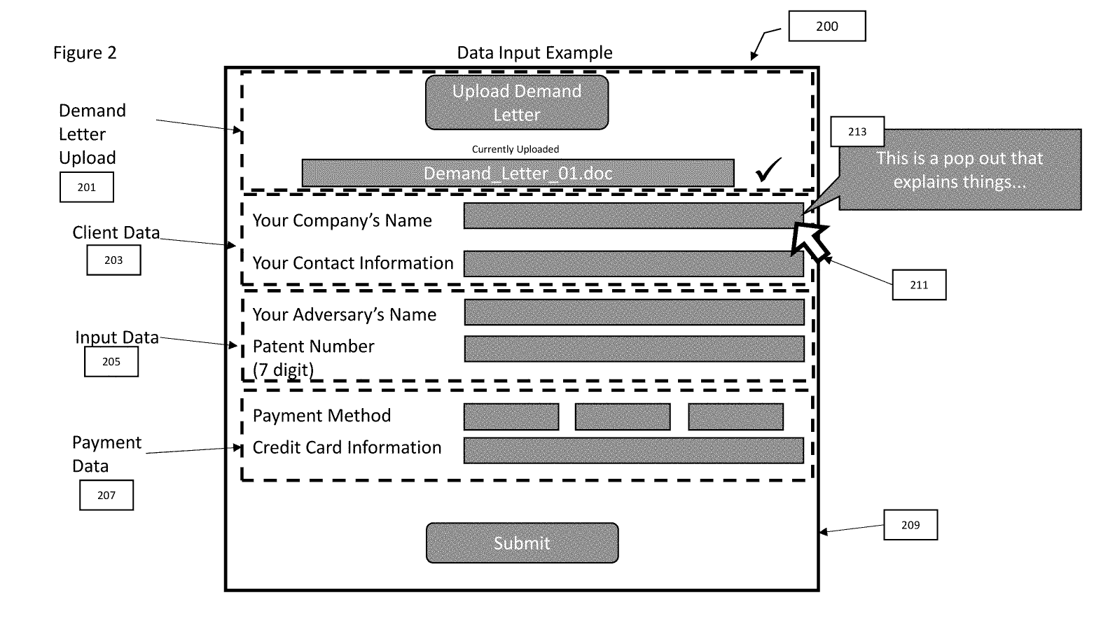

FIG. 2 generally depicts an example of a user interface 200 comprising a user input form 209 that may be displayed as part of a website or an application, such as the user interface of FIG. 1. The user interface 200 includes a demand letter upload section 201, which may include the upload demand letter button 101, upload status indicator 103, uploaded document name 105, and/or success icons 107 as described in relation to FIG. 1. The demand letter upload section 201 may appear anywhere in the user interface, or in its own user interface or browser window which may pop up before or after the rest of the user data is entered or submitted.

The user interface 200 may comprise a client data section 203 which includes fields where a user can enter information about themselves or their business. There may be certain restrictions on what a user can enter in the client data section 203. For example, if a company's name is too short, an indication may appear or the submit button 109 may use kick-back functionality when a user attempts to submit the user input form. The client data section 203 may not require that client data is entered into the user input form before the user input form is submitted, however. Reports may still be generated without a user's name or the name of the user's business. Alternatively, a user's name or the name of the user's business may be obtained directly from an uploaded demand letter, such as by Optical Character Recognition (OCR) or manually by an analyst. If the user's name or the name of the user's business cannot be obtained from an uploaded demand letter, these fields may be shown to the user with an indication that the user needs to input the information. Fields that may be included in the client data section 203 may comprise, but are not limited to company or business name; contact information such as address, phone number, and email address; state of residence, as different states have different demand letter laws that may affect the report; opt-in check boxes for participating in a testimonial, promotional material or offers, or if the user is interested in having their contact information saved and made available to other clients who have been issued demand letters under similar circumstances (same adversary, same patent, or same law firm or lawyer), for example; and a title or position of the person submitting the request for the report, such as inside counsel or CEO, for example.

The user interface 200 may also comprise an input data section 205, which may consist of fields for entering information that the system is unable to extract from the demand letter, or is supplementary to the information provided in the demand letter. Fields that may be included in the input data section 205 may comprise, but are not limited to the adversary's name; the adversary's legal representation; patent number(s) asserted in the demand letter; total number of patents asserted in the demand letter, if there is more than one patent asserted; whether a claim chart has been included with the demand letter; and any other items of intellectual property that are mentioned in the demand letter, such as a trademark.

The user interface 200 may further comprise a payment data section 207. The payment data section 207 may use standard payment processing functionality, and may be done through a third-party payment processor. The payment data section 207 may appear in a different window or on another page of a website in the user interface. A user may enter credit card information in the payment data section 207 and confirm payment.

The user input form 209 comprises the constituent sections 201-207 described above. The user input form 209 may appear as a page on a website that a user can navigate to on the website. Alternatively, the user input form 209 may appear in a pop-up window as a result of a user clicking a “Buy Now” button, for example.

The user interface 200 may also enable a user to hover over portions of the user input form 209 and cause a preview window 211 to appear, which may contain information relating to the input field over which the user is hovering. The user may be able to hover over the form window 209, any of the sections 201-207, or specific fields to initiate a preview window 211 to appear with further information 213. The information 213 may comprise information such as definitions of a field or restrictions on what may be entered in a field. For example, the field may require a seven digit number to be entered. Hovering over the field causes a preview window 211 to appear with information 213 that says “Must be a 7-digit number.”

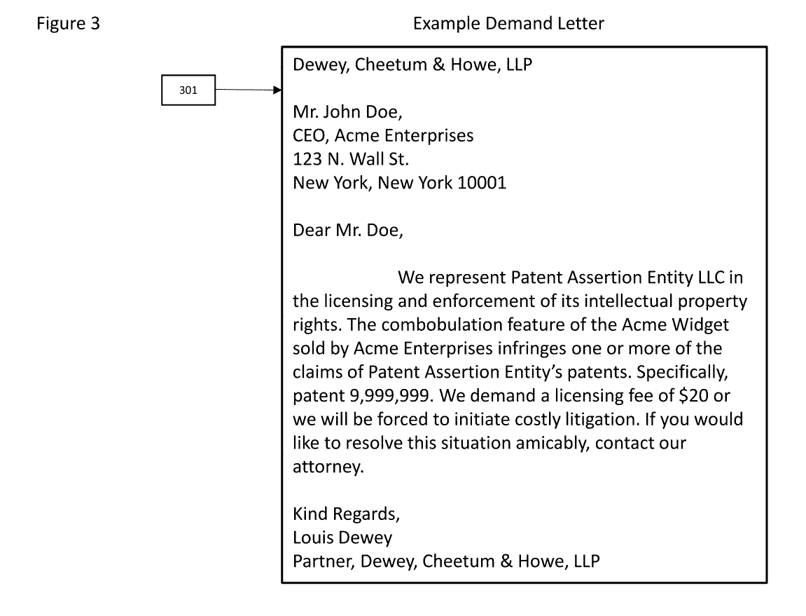

FIG. 3 depicts an example demand letter, generally at 301.

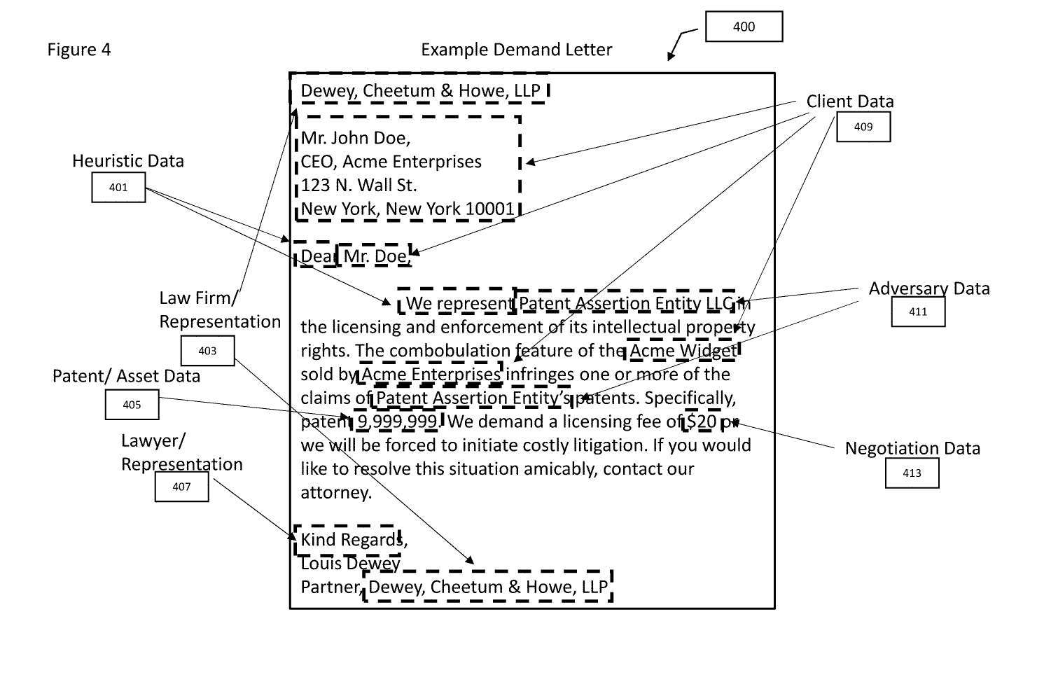

FIG. 4 depicts an example demand letter 400, such as the example demand letter 301 of FIG. 3, along with different items of information contained in the demand letter indicated that can be extracted for analysis. The items of information can be identified by a human, who may have a rubric of what to look for in the demand letter. Alternatively or additionally, the items of information in the demand letter 400 can be identified automatically by a computing system, using techniques such as OCR. Words may be identified for extraction using string patterns that fit into certain categories. For example, the system may assume all 7-digit numbers go into the “patent number” field, except for when they are in a form comprising hyphens such as XXX-XXXX (e.g., a phone number). Alternatively or additionally, a machine learning algorithm may be used. In this scenario, analysts read a number of demand letters forming a corpus of demand letters (several hundred, for example). The analysists then enter corresponding information from each demand letter into a database (such as patent number, adversary data, lawyer/representation, etc.). Then, a natural language processing or machine learning algorithm is run on the corpus. The algorithm learns, in one example, that whenever a 7 digit number pops up, to take that number and label it as the patent number, and goes through a similar process for information in multiple demand letters.

The demand letter 400 may include heuristic data 401, which represents any words, letters, spacing, or punctuation that is used to identify useful information. In the example shown, “Mr. Doe” is a useful piece of Client Data 409. We know that “Mr. Doe” fits into the category of “Client Name” because the heuristic data (specifically, “Dear” used as a salutation) is usually followed by the recipient's name, followed by a comma or semi-colon, and then an empty line. Certain other phrases, such as “we represent” may identify the adversary's name (e.g., the adversary's name immediately following “we represent”). Both of these examples had the heuristic data precede the extracted information, but it could just as easily come after.

Heuristic data 401 may be useful for both human and machine data extraction. As discussed above, a rubric may be created for analysts to use to help them navigate demand letters that will have charts and tables of heuristics and their effect on the language around them. This, of course, can be coded into a programmatic solution as well.

The demand letter 400 may include a name of the adversary's legal representation, such as law firm name 403. The law firm name 403 is extracted for later use in generating various sections of the report, such as a Lawyer Assessment section. There may only be one law firm name 403 in the demand letter, but there may be more. The law firm name 403 may be signified by headings, footings, watermarks, or disclaimers in the demand letter. Law firm names 403 often follow a set of patterns, and as such may be relatively easy to extract. Many times the law firm name 403 has “LLP” or “PLLC” at the end. Law firm names 403 often have several commas as well. In one implementation, the system may check a database of law firm names to try and find a matching name within the document. Additionally or alternatively a fuzzy matching algorithm may be used to determine the law firm name. If no law firm name is found, a computing system may flag the demand letter for further analysis (perhaps by a human analyst).

The demand letter 400 may include patent (or asset) data 405, which can be extracted for use in generating various sections of the report, such as the Patent Assessment section. There may be more than one patent mentioned in the demand letter 400. The patent data 405 may comprise patent numbers, but may also comprise patent application numbers or provisional patent numbers. Because patent application numbers and provisional patent numbers do not necessarily mean that the applicant has any enforceable rights, they may be handled differently than patent grant numbers. For example, if a patent application number is found, the computing system (or analyst) may cross-reference the patent application number to see if it has a corresponding grant number. If there is a corresponding grant number, then the grant number can be entered into the computing system. If there is no corresponding grant number, the demand letter 400 may be marked as the adversary having no actual patent rights, which may affect the subsequent analysis sections of the report.

Because patents can exist and have different types of rights in various jurisdictions (such as different countries), a jurisdiction of each patent may be extracted when available. For example, if the only patents mentioned in a demand letter are German, the computing system can include a note in the Patent Assessment section of this, and be altered based on this information.

In the demand letter 400, patent data 405 may be missing or incomplete. In this case, additional data on the patent may be extracted from various sources. In some cases, the adversary may not mention any patents specifically, may mention a “portfolio” of patents, or simply refer to a patent or asset as “proprietary technology” or the like. In this case, the computing system may include a process of using the adversary's name, or other identification information, to look up any patents or assets owned by that entity. This data may then be used as the patent data 405. Other data may also be used, including but not limited to previous litigation data, negotiation data, client data, heuristic data, and other data to narrow down patents owned by the adversary to a most likely subset of patents that the adversary is asserting in the demand letter. For example, an adversary owns two patents, one related to semiconductors and one related to clown shoes. The recipient of the demand letter's business is in semiconductors but the demand letter does not specify a particular patent, only stating that the recipient of the demand letter has “infringed our technology.” The analyst or computing system may determine that the clown shoe patent is not applicable in this case, and will only consider the semiconductor patent in the subsequent analysis.

The demand letter 400 may include lawyer (or representation) data 407. The lawyer data 407 may be related to the law firm name 403, but may include several differences that warrant explanation and separation of the two types of data. Both law firms and individual lawyers have representative and historical statistics, which may not be perfectly aligned. For example, a superstar lawyer (great win/loss record) may be working for a firm that has a poor win/loss record overall. In the example shown, Louis Dewey of Dewey, Cheetum & Howe, LLP is indicated as the drafter of the letter. The computing system may query a database of law firms/lawyers and find that Louis Dewey is a named partner at Dewey, Cheetum, & Howe, LLP. Having a named partner draft a letter may indicate that the firm has assigned greater importance to this matter than if an associate had written the letter. This may be reflected in later analysis. Therefore, it may be useful to further distinguish representation by law firm and lawyer.

The demand letter 400 may include client data 409, which refers to any data extracted from the demand letter about the recipient of the demand letter, but may also include information entered by a recipient of the demand letter via the client data section 203 described above. The client data 409 may include information such as a company or business name, names of individuals in the company or business, addresses, phone numbers, email addresses, products, services, agreements, vendors, or features, to name a few examples.

In some cases, a recipient of a demand letter may be wary of online agents (including a provider of the services and the reports as described herein) extracting or storing information about the recipient of the demand letter. To address these concerns, pieces of information may be redacted after they have been identified in the demand letter. This may include scrambling, or blacking out, sections of demand letter documents that have been processed using OCR, deleting database fields and the like, or simply storing such information behind additional security measures, such as passwords. In some cases, only data in a demand letter that meets certain requirements is subject to redaction, deletion, or heightened security. For example, it may be acceptable to analyze and/or display the names of people that work at the company but not acceptable to analyze and/or display product names.

The demand letter 400 may include adversary data 411, which may refer to any available data about the adversary and may be used in sections of the report such as the Adversary Assessment section. Adversary data 411 may include information such as an adversary name, aliases, addresses, phone numbers, email addresses, license agreements, other agreements, products, services, company structure, subsidiaries, or parent companies. Similar to the patent data 405, some of this information may be inferred or looked up through other data sources than the demand letter 400 itself.

The demand letter 400 may include negotiation data 413, which may refer to information about an offer or negotiation presented in the demand letter or the dispute in general. Negotiation data may include various dates of letters, correspondences, or offers; demands, dollar amounts, or proposed payment schemes/structures; reactions to anything mentioned above; or threats of litigation or other measures. This data may naturally change throughout the dispute and/or litigation but may be useful for analysis. For example, a demanded licensing fee might be compared to the average cost of patent litigation. If multiple demand letters are analyzed within the same dispute, there may be analysis performed on the difference in various negotiation data points, for example, an increase in the demanded license fee in later demand letters. A demand letter may additionally be analyzed for tone, such as by analyzing word choice, use of bold or italic fonts, or punctuation, for example, which may be yet another component of negotiation data 413.

FIG. 5 depicts an example section 501 of an example demand letter forecasting report in accordance with one or more implementations. The example section 501 may be part of a word processing document, part of a PDF document, or rendered in a website or application, for example.

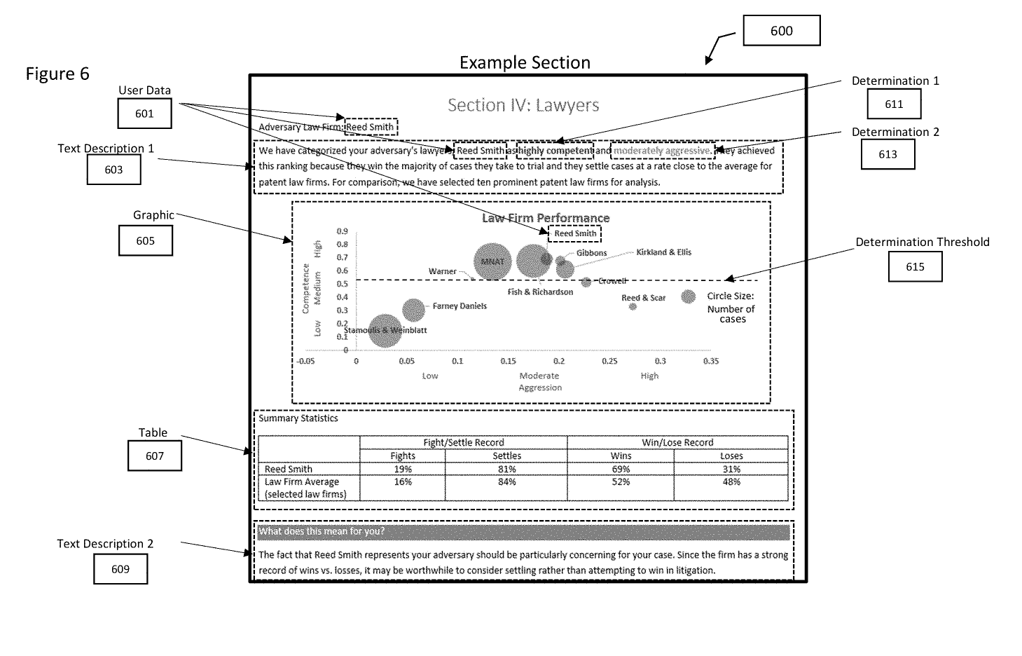

FIG. 6 depicts an example section 600 of an example demand letter forecasting report, such as the example section 501 of FIG. 5. The example section 600 may be broken down into multiple components. Sections in a report may generally have the same components, in the same order, with differences occurring in the content within each component from section to section. However, in some cases, if data is unavailable or insufficient for what is required for a component of a particular section, a component may not be included or displayed in the section. In many cases, components may conform to certain size restrictions so as to maintain certain page limitations and aesthetic appearance of the section of the report. If one component includes more content than can be reasonably fit within a default allotted space for the component, another component may be resized to accommodate the component that requires more space in the section, such as via removal of words, graphic/table resizing, font changes, etc.

The example section 600 may include input data and user data 601, which may include data extracted from the demand letter 403-413 of FIG. 4, and/or data from the user input form 203, 205 of FIG. 2. In the example section 600, the law firm name 403 is Reed Smith. According to a template for the example section 600, the law firm name populates several different portions of the section and the section's constituent components. There may be components that simply indicate what a user input was or where the user input came from (such as the “Adversary Law Firm: Reed Smith” text included in the example section 600). Components may populate with a natural language description 603. Components may also populate with labels or indicators on a graphic 605, or in a table 607, to name some examples. As should be readily understood, the input data and user data 601 is not limited to a law firm name; one could easily comprehend a patent number, for example, populating various portions of one or more sections of a demand letter forecasting report.

The example section 600 may include a first language description 603, which may comprise a description in plain English (although other languages are contemplated) describing to a user context for the determination, table, and/or graphic; methodology for the determination, table, and/or graphic; results of the determination, table, and/or graphic; and/or implications of the determination, table, and/or graphic.

The example section 600 may include a graphic 605, which is a visual representation to assist in understanding features, characteristics, calculations, and/or results of the user data and input data 601 and any external data used for analysis of the input data and user data 601. The graphic 605 might take the form of a bar chart, line chart, pie chart, fuel gauge, donut chart, bubble chart, xy plot, flowchart, histogram, timeline, infographic, or some other chart or visualization. The graphic 605 may make use of pre-programmed comparisons. In the example shown, numerous other law firms are pre-programmed into the graphic 605 to allow the user to compare the adversary law firm (Reed Smith in this example) to other law firms.

Calculations may be performed to transform, scale, or modify the input data and user data 601 and/or pre-programmed or external data for use in graphics. Data fields or attributes of the input data and user data 601 may be queried, stored, and/or calculated to create the graphics. In the example section 600 shown, data including number of cases from years 2011-2015, Claimant Win, Claim Defendant Win, Procedural Dismissal, Settlement, No Litigation Result, and Plaintiff/Defendant Representation were extracted from one or more data sources for each of the law firms shown. A decay function is applied to the number of cases years 2011-2015 to reduce the impact of older cases. A function adding together all favorable outcomes (claimant win if representing plaintiff, defendant win if representing defendant) divided by all “decided” cases (any claimant or defendant win) is used to determine the positioning of each law firm on the y axis (Loses/Wins). A similar function is used to plot the x axis comparing settled cases to decided ones.

The example section 600 may include a table 607 comprising one or more components. The table 607 may be populated by the input data and user data 601 and/or pre-programmed or external data.

The example section 600 may include an additional language description 609. There may be multiple different language descriptions within a section. The language descriptions 603 and 609 may describe different corresponding graphics, tables or determinations, or describe the same component in a different way.

The example section 600 may include a first determination 611. In one or more implementations, each section will have at least one determination. The first determination 611 may be at least partially a function of the input data and user data 601. The first determination 611 may also be a function of pre-programmed data or external data. The first determination 611 may take the form of a word or combination of words, a number, a ratio, a currency value, a risk level, or some other metric. The first determination 611 may have some associated score value which may or may not be displayed or otherwise made known to a user. Determinations may be selected from a range of possible determinations by inputting the input data and user data 601 into a preprogrammed process or function, but may alternatively or additionally be selected based on other possibilities.

In the example section 600 shown, the first determination 611 is “highly competent.” The first determination 611 in the example section 600 is calculated by querying a data source for statistics associated with the law firm Reed Smith. The name of the law firm Reed Smith is extracted from a demand letter, in this example. A function of the demand letter forecasting system returned a score of 0.68 for the win/loss metric for the law firm Reed Smith. This put Reed Smith into the highest quartile when compared to other law firms. An indicator associated with a law firm being in the highest quartile is “highly competent” written in a bold-red text. As such, this indicator populated the corresponding spot in the first language description 603. An associated score value of 4 out of a possible 4 points was contributed to a composite score, which is discussed in more detail below.

The example section 600 may also include one or more additional determinations 613. An additional determination 613 may have its own associated word combination, input/user data, method of calculation, contribution to composite score and/or include any feature of the first determination. The first determination 611 and the second determination 613 may or may not affect each other's contribution scores, methods of calculation, or word combinations.

The example section 600 may include one or more determination thresholds 615. Similar to the discussion of the first determination 611, there may be pre-calculated determination thresholds 615 for deciding which determination will be presented among a range of possible determinations. Determination thresholds 615 may be invisible to the user (as in the example section 600 shown) or in other cases, displayed to the user.

FIG. 7 depicts an example section 701 comprising various example components in accordance with one or more implementations. A section can be understood as a class object in object-oriented programming, for instance, and as such contains properties and methods, at least some of which are performed by a computer. A section instantiates a visual representation of a section, such as section 501 of FIG. 5. The example section 701 may have at least one determination 703, a contribution score 707, and may contain any number of graphics 709, tables 711, and explanations 713. The example section 701 may have predefined functions for calculating determinations 703 and contribution scores 707, rendering graphics 709, and/or populating tables 711 and explanations 713.

The determinations 703 may comprise features as discussed in relation to the determination 611 of FIG. 6. Each section 701 may have at least one determination 703. In instances where there is more than one determination 703, different determinations within a section may measure different metrics and exist on different scales. For example, a section which analyzes a patent may have one determination indicating likelihood of validity of the patent, and another determination indicating a scope of the patent. Validity may be measured on a scale of probabilities whereas patent scope may be measured relationally to other patents, as in, “this patent is broader than 80% of patents in its patent class.”

The contribution scores 707 are values associated with a determination 703 of the example section 701. The contribution scores 707 are used to calculate a composite score for the report, where the composite score combines multiple contribution scores from various sections in some fashion. Contribution scores 707 may derive from a determination 703 or vice versa. In the instances where there is more than one determination 703, there may be more than one contribution score 707. Alternatively, two determinations 703 may have associated intermediate contribution scores that interact in some way to product the section contribution score 707. Returning to the example regarding patent validity and patent scope, the validity probability may be 50% and the patent scope may be 80% (e.g., broader than 80% of patents in its class). These two numbers may be multiplied together to determine an overall contribution score 707 for the example section 701. Alternatively, the two numbers may be added together, one divided by the other, or combined using some other calculation. Alternatively, multiple numbers may also contribute a score independently of each other (e.g., to provide multiple contribution scores per section).

Each section may have one or more graphics 709, which are discussed in detail in relation to graphic 605 of FIG. 6.

Each section may have one or more tables 711, which are discussed in detail in relation to table 607 of FIG. 6. Tables 711 may present the data used to create a graphic 709, but may also present other data. For example, certain litigation data may be used create a graphic 709 which shows a company's temperament in litigation by plotting how often a company settles lawsuits vs. how many times the company pursues litigation to a decision. There may be an accompanying table 711 which lists all of the litigations the company has been involved in and the result (e.g., a settlement or a decision). Tables 711 may also display data that is unrelated to a specific graphic 709.

Each section may have one or more explanations 713, which are discussed in detail in relation to the descriptions 603 and 609 of FIG. 6. Explanations 713 may be automatically generated by a computing device or written by an analyst, for example.

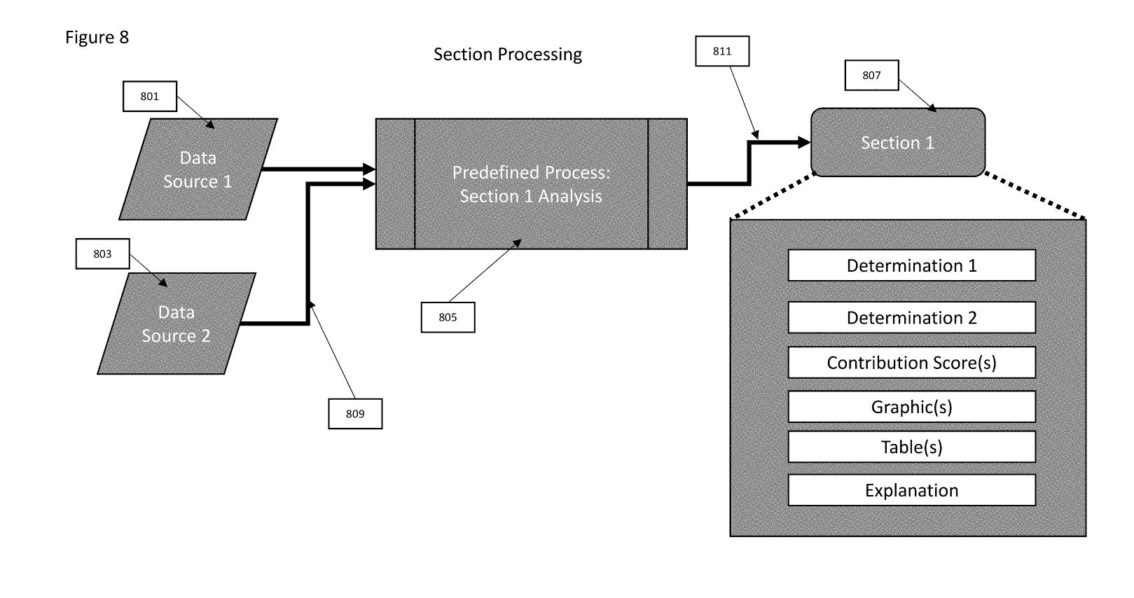

FIG. 8 depicts an example of section processing in accordance with one or more embodiments. As explained above, a section can be understood as a class in object-oriented programming, and as such contains properties and methods, at least some of which are performed by a computer. In this example, a first data source 801 and a second data source 803 are provided as inputs to a predefined process 805, which may include analysis for a first section 807. In this example, the first data source 801 and the second data source 803 are a third-party databases accessible via the Internet. Alternately or additionally, internal, recently-used, cached, or historical databases may also be accessed as data sources 801 and 803, such as various docketing, court filing, and research databases.

In many cases, multiple different data sources are used in conjunction with one another to provide necessary data for analysis. For example, a specific patent litigation case can be searched for in a searchable research databases service such as Docket Navigator™ The research database service will display which patents were used in the patent litigation case. But the research database service may not maintain an extensive list of patent attributes. The patent numbers may be taken from search results of the research database service, either by an analyst or by one or more computing processes, and used to query the database of a patent search and analysis database service such as Relecura™. In this way, the analyst or system can access a large array of patent attributes such as inventor or patent citations. Going even further, the analyst or system may use the resulting inventors' names to query a social networking database such as LinkedIn™. The query may return the current employer of the inventors whose patents are litigated in a particular case. By combining data results from these three data sources, the analyst and/or system is able to answer particularly interesting questions that one source alone could not answer.

One example of a data source is a searchable research database service such as Docket Navigator™, which is a searchable database of patent litigation documents, results, courts, judges, parties, lawyers, law firms, dates, case statuses, remedies, and patents. Another example data source is Lex Machina™, which is similar to Docket Navigator™ and may provide some or all of the same data/fields with additional visualization and charting features. Yet another example of a data source is Relecura™, a searchable database with domestic (U.S.) and international patent filings with a wide array of patent attributes including but not limited to: application numbers, grant numbers, priority dates, patent families, citations (forward and backward), inventors, owners, and patent classes. Relecura™ or other data sources may also support conceptual searching that allows a user to submit documents (in whole or part), for scoring against the corpus of one or more patents and returns one or more similar patent documents.

Other example data sources include IP Street™, Owler™, Hoovers™ LinkedIn™, Microsoft™ Academic Search, DocketBird™. DocketBird™ is similar to Docket Navigator™, allowing for search of patent litigation documents and other functionality explained above. IP Street™ is similar to Relecura™, featuring many or all of a patent's or group of patents' attributes and supporting conceptual search. IP Street™ also supports a claim scope algorithm which ranks all patents in a particular U.S. class from broadest to narrowest. Owler™ maintains a user-curated database of company data including but not limited to: company officers, revenue, company location, and company news. Hoovers™ is a database with company data, similar to Owler™. LinkedIn™ is a business-oriented social networking service. LinkedIn™ maintains employment status and history of professionals, such as attorneys. Microsoft Academic Search™ is a searchable database of research publications. All of these are merely examples of services and are not meant to be limiting. Each example may have one or more competitors with similar functionality and may be employed in a similar manner.

In one implementation, data sources 801 and 803 are accessed manually by an analyst. The analyst uses a component of data or documents input by a user as a search seed to query one or more of the data sources 801 and 803. The analyst may then copy or retrieve the results, or a specific subsection of the results displayed by the data source. In another implementation, the data sources 801 and 803 may be accessed via an API (Application Program Interface). A component of data or documents input by a user may be used by the API as part of a search seed to query one or more of the data sources 801 and 803, and results may be automatically identified, retrieved, and/or stored for use in the first section 807. Additionally or alternatively, data sources may be accessed via techniques known as web scraping, whereby data is extracted from a website programmatically through http or by embedding a web browser, for example.

Each section of a report may have its own predefined methods for producing determinations, contribution scores, graphics, tables and explanations for the section, which is indicated as predefined process 805. In but one example, the Court Assessment section uses data or documents input by a user to discern the most likely court venue for potential litigation between the recipient of the demand letter and the recipient's adversary. There may be several methods to discern the most likely court venue but for this example, assume that the venue that has the closest distance to the adversary's company address is used. The predefined process 805 for the Court Assessment section will extract the address from the demand letter, and methods for querying a data source to find the closest proximal court venue. Once the closest proximal court venue is retrieved, the predefined process 805 for the Court Assessment section queries a second data source to ascertain the record of plaintiff wins and defendant wins for that court venue. The predefined process 805 of the Court Assessment section may compare the plaintiff and defendant wins to produce a “plaintiff favorability ratio.” The “plaintiff favorability ratio” of a sample of court venues is used in presentation of the Court Assessment section for illustrative comparisons. The predefined process 805 of the Court Assessment section may also compare computed plaintiff favorability ratios of the venue in question with plaintiff favorability ratios of other venues. If the venue in question has, for example, a plaintiff favorability ratio that is above the average of the other venues (or alternatively, a threshold score—for example 50%), the predefined process 805 of the Court Assessment section may assign a determination of “plaintiff friendly,” which may be displayed in the section of the report, and/or used in other processes in the Court Assessment section or other sections of the report.

Additionally, continuing with the above example, a graphic in the Court Assessment section may have the sample venue's plaintiff favorability ratio plotted on an axis. The venue in question may then be plotted on the same plot using the venue's calculated plaintiff favorability ratio.

Similarly, a set of stored language combinations may be assigned to different plaintiff favorability ratios. The stored language combinations may be used to populate an explanation of a section. For example, if the plaintiff favorability ratio is assigned a determination of “plaintiff friendly,” the explanation may include a sentence such as, “This court venue is particularly favorable to plaintiffs” from a stored language combination. However, if the plaintiff favorability ratio is assigned a determination of “defendant friendly” the explanation may instead include a sentence such as, “This court venue is less desirable for plaintiffs as plaintiffs have a hard time winning here” from a stored language combination.

The result of the predefined process 805 is generation of a section 807, which may be in accordance with section 701 of FIG. 7.

Data may be transferred, copied, or extracted from one or more of the data sources 801 and 803 using analyst-defined queries or via an API, as discussed above, via source data retrieval 809. The data may be transferred via an internet or intranet connection, to name a few examples.

The section 807 generated from the predefined process 805 may be inserted via processed data insertion 811 into a section instance as a linked object or embedded object, for example. An illustrative example of processed data insertion 811 is Microsoft Office™'s dynamic link functionality between Microsoft Excel and Microsoft Word. A user can copy a selected group of cells or graphic and, through a special paste command, copy them to Microsoft Word document. When copied in this way, changing the cells in the corresponding Excel document changes the corresponding cells in the Word document. By using this functionality, a predefined process 805 for a particular section 807 may be reused for different instances of the section and the results can be updated merely by updating various input cells based on different information or documents from different demand letter recipients.

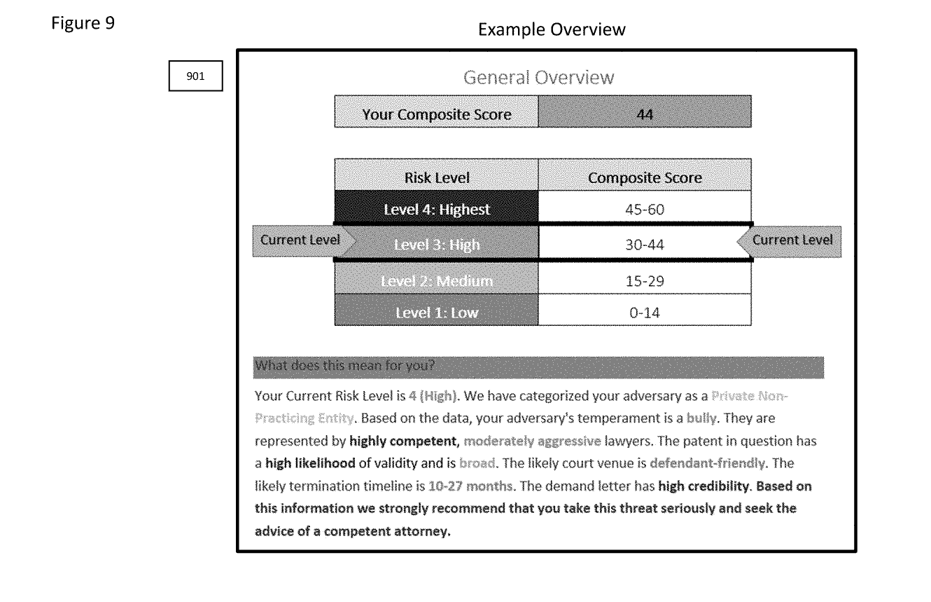

FIG. 9 depicts an example demand letter forecasting report overview, generally at 901.

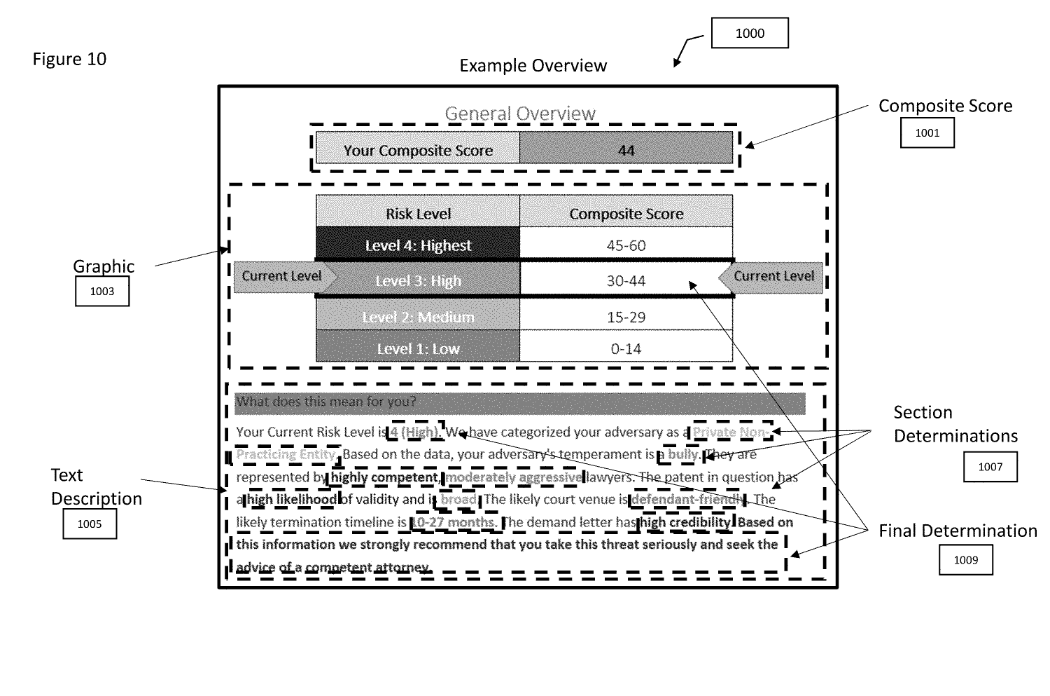

FIG. 10 depicts further details of an example demand letter forecasting report overview 1000, such as the example demand letter forecasting report overview of FIG. 9. The demand letter forecasting report overview 1000 may have a composite score 1001, which is determined by compiling the contribution scores of each section of the report (excluding the overview section) according to some pre-defined schema. In a basic example, the contribution scores of each section may simply be added together to achieve the composite score 1001. The composite score 1001 may then be mapped to a general determination 1011 (explained in further detail below).

The demand letter forecasting report overview 1000 may comprise one or more graphics 1003, providing a graphical depiction of the composite score 1001. The graphic 1003 may present the composite score 1001 on a continuum or other representation to provide context for the user. In the example shown, there are four distinct score ranges with corresponding labels and coloring. The composite score 1001 in this example falls into the Level 3 score range, and that range is indicated in the graphic 1003 accordingly. The graphic 1003 depicting the composite score 1001 may take a variety forms. A fuel gauge graphic may be used or some other type of graphic.

The demand letter forecasting report overview 1000 may comprise one or more text descriptions 1005. The text description 1005 is a series of sentences or phrases generated by an analyst or the computing system according to a program or rubric, and corresponds to results of the section determinations. The text description 1005 may also have a sentence or phrase describing the composite score 1001 and/or the final determination 1009 (discussed in further detail below).

The demand letter forecasting report overview 1000 may comprise one or more section determinations 1007. As discussed above, each section of a demand letter forecasting report may have at least one determination. In addition to being displayed within each section of the report, the determinations of each section (or any number of additional sections) may also be displayed as section determinations 1007 in the demand letter forecasting report overview 1000 as part of the text description 1005.

The demand letter forecasting report overview 1000 may comprise a final determination 1009, which is a description associated with the composite score 1001. In the example shown, the composite score 1001 was 44, which falls into the range of values in Level 3: High. The composite score 1001 falling into the range of values of Level 3: High resulted in inclusion of the sentences in the text description 1005, “Your Current Level is 3 (High)” and “Based on this information we strongly recommend that you take this threat seriously and seek the advice of a competent attorney.”

In an alternative scenario, the composite score 1001 may have been 8. This would have corresponded to the “Level 1: Low” range of values. In this example, the first sentence in the text description 1005 might read, “Your Current Risk Level is 1 (Low).” The final sentence in the text description 1005 might read, “Based on this information the threat is not likely credible and may not warrant immediate action. However, it is always a good idea to seek the opinion of a competent attorney.” It is important to remember that different report types may have different ranges of values and therefore different composite scores may correspond to different final determinations. The risk levels, score ranges, and language descriptions presented herein are intended only as examples, and are not intended to be limiting.

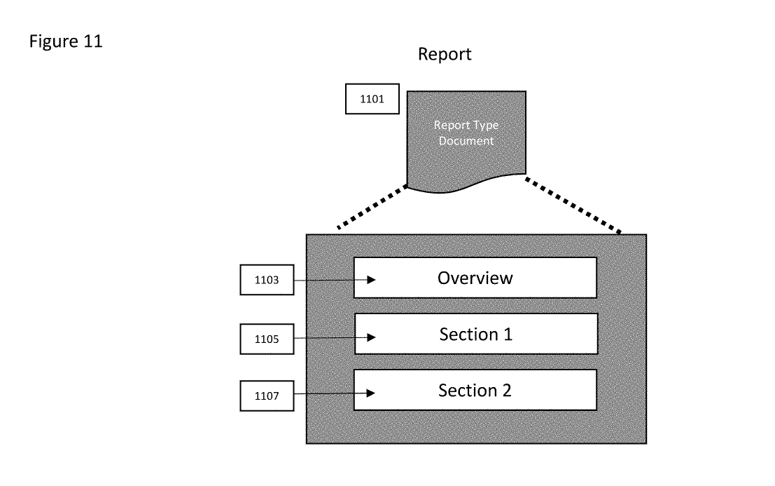

FIG. 11 depicts an example report type document 1101 and example content of the report type document 1101. Each report type document 1101 may have an overview 1103 and constituent sections 1105 and 1107. Different report type documents 1101 may have different numbers of constituent sections (the two sections 1105 and 1107 are but one example of a possible number of constituent sections), combinations of constituent sections, orders of sections, graphics, and composite score schemas.

The example report type document 1101 may comprise an overview 1103, which may be in accordance with the demand letter forecasting report overview 1000 described in relation to FIG. 10. The example report type document 1101 may further comprise one or more sections 1105 and 1107, such as the sections described in relation to FIGS. 6 and 7.

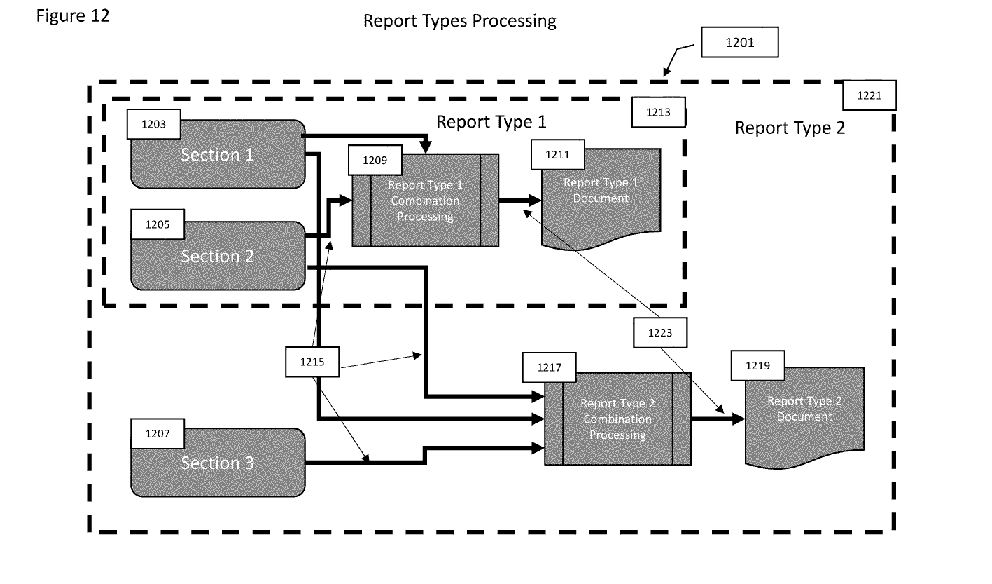

FIG. 12 depicts an example system 1201 for generating reports of different types. In one or more implementations, a first section 1203 and a second section 1205 are used in a first report type combination processing 1209. The first section 1203 and the second section 1205 may be in accordance with the description of the sections described in relation to FIGS. 6, 7, and 11. The first report type combination processing 1209, also described in relation to FIG. 10, involves combining or compiling contribution scores of each constituent section 1203 and 1205 to reach a composite score, resulting in the generation of a final determination for the report. The first report type combination processing 1209 may also include combining complete sections in a pre-defined order according to a particular report type. The first report type combination processing 1209 may also include pagination and/or orientation tasks to create a more aesthetic appearance for the report, such as formatting adjustments (e.g., font, size, graphic dimensions, and so forth) for some or all of the constituent sections 1203 and 1205. The first report type combination processing 1209 may also include adding cover sheets, appendices or other auxiliary pages to the report. The first report type combination processing 1209 may also be pre-defined for each report type.

The result of the first report type combination processing 1209 is a first report type document 1211. The first report type document 1211 is an electronic (e.g., Word, PDF, and so forth) or physical document instantiated by a first report type process 1213. The first report type document 1211 may exist as an empty template, for instance before data is entered and the first report type process 1213 is run, or as a completed report including data entered into a template, for example.

In order to execute the first report type combination processing 1209, section data retrieval 1215 may be executed. Section data retrieval 1215 may comprise locating and processing certain data from the constituent sections. For example, contribution scores may undergo report type combination processing, but the report type combination processing may be different for each type of report. For example, the first report type document 1211 may only add contribution scores for each of the sections 1203 and 1205 in order to reach a composite score. However, a second report type combination processing 1217 may have contribution scores for sections 1203 and 1205 added together, while a contribution score for section 1207 has a multiplicative effect on the sum of sections 1203 and 1205. Therefore, each report type may have an entirely different contribution and composite score schema.

Some data that is present in the sections 1203-1205 may not be included in the first or second report type combination processing 1209 and 1217. For example, graphical data, such as that found in the graphic 605 of FIG. 6, may not undergo combination processing in certain implementations. Once generated during the creation of a section, that section's graphic may be passed directly on to the final report without undergoing any change, or even being read by the system, during first and second report type combination processing 1209 and 1217.

Different report types may have different schemas or methods of executing combination processing. There may be any number of report types and associated combination processing schemas. These may use have different constituent section combinations or included sections as discussed above. In the example shown, a second report type combination processing 1217 includes processing of the first section 1203, the second section 1205, and the third section 1207, while the first report type combination processing 1209 only processed information from sections 1203 and 1205. The result of the second report type combination processing 1217 is a second report type document 1219, which is distinct from the first report type document 1211, in both the number of constituent sections as well as the method and schema of their combination in this example. Further, the second report type process 1221 is in accordance with the description of the first report type process 1213, but having a different number of sections, combination processing, and resultant document.

When the first report type document 1211 and the second report type document 1219 are generated, the information in the report types undergoes a report population process 1223. The report population process 1223 may be in accordance with the description of the processed data insertion 811 of FIG. 8, except that the end result is a result of the combination processing 1209 and 1217 that populates the report, such as an overview section of the report. This may include the composite score 1001, one or more graphics 1003, one or more language descriptions 1005, and a final determination 1009 as described in relation to FIG. 10.

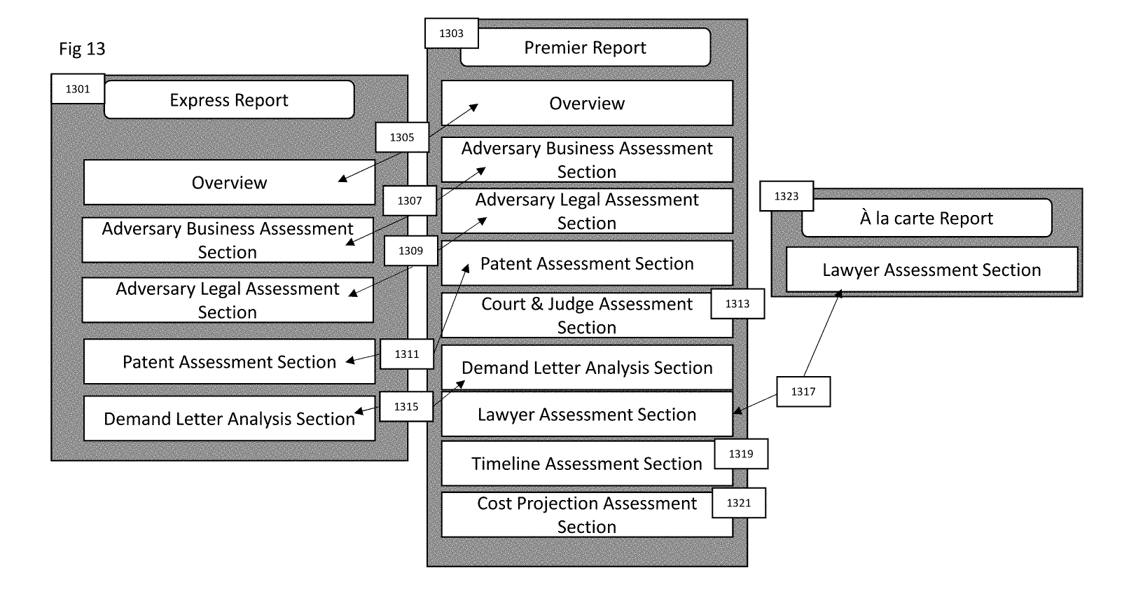

FIG. 13 generally depicts three illustrative examples of report types 1301, 1303, 1323 with examples of each report type's constituent sections. An Express report 1301 may contain an overview 1305, an Adversary Business Assessment Section 1307, an Adversary Legal Assessment Section 1309, a Patent Assessment Section 1311, and a Demand Letter Analysis Section 1315, examples of which are provided above and below.

A Premier report 1303 may contain an overview 1305, an Adversary Business Assessment Section 1307, an Adversary Legal Assessment Section 1309, a Patent Assessment Section 1311, a Court & Judge Assessment Section 1313, a Demand Letter Analysis Section 1315, a Lawyer Assessment Section 1317, a Timeline Assessment Section 1319, and a Cost Projection Assessment Section 1321. As shown, the Premier report 1303 has more sections than the Express report, although other embodiments are also contemplated.

An À la carte report 1323 may contain just a single section such as a Lawyer Assessment Section or other type of section, or may contain multiple sections. The À la carte report 1323 may be provided to users as an option to select sections that they wish to have generated in their report in lieu of sections that the user does not wish to have in the report, allowing users to customize which sections will appear in a report.

Certain sections may contain the same or similar information to their counterparts in different report types. For example, an Adversary Business Assessment Section 1307 may comprise the same information when it is generated for an Express report as it is generated for a Premier report. In the example shown, the same or similar information may appear in sections 1307, 1309, 1311, and 1315. On the other hand, certain sections may comprise different information to their counterparts in different report types. For example, a Patent Assessment Section 1311 may contain a more detailed analysis in the Premier report type than when the Patent Assessment Section 1311 is generated for the Express report type.

The report types 1301, 1303, and 1323 are not meant to be limiting by way of section ordering. Section order may be set for each report type, or may be the result of some other logical rule such as ordered by their respective scores. For example, an Express Report 1301 may contain a Demand Letter Analysis Section 1315 that has a particularly high determination or contribution score. Accordingly, the Demand Letter Analysis Section 1315 in this example may be displayed first in the report because of its high score. Lower-scoring sections may follow the Demand Letter Analysis Section 1315 in the Express Report 1301. Alternatively, the same Demand Letter Analysis Section 1315 may be shown last in the Express Report 1301 because of its high score, or some other specific ordering.

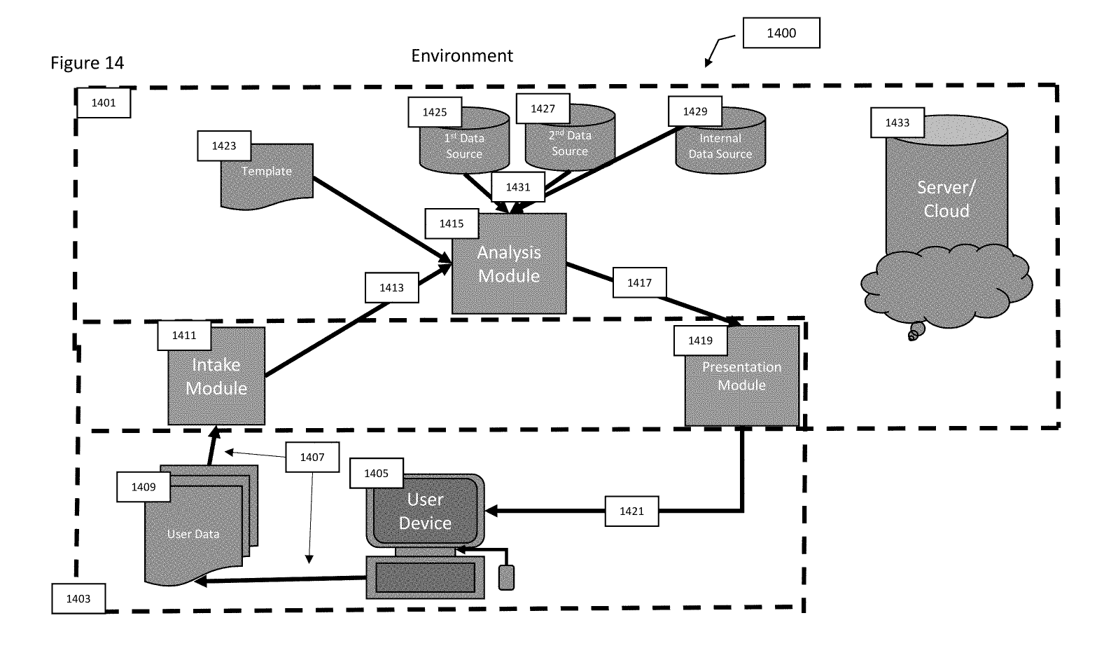

FIG. 14 depicts a general flow of information between a user device and a service 1400 for generating demand letter forecasting reports. The service 1400 may comprise internal elements 1401, which may be performed in part by an analyst, or performed in whole or in part programmatically via one or more computing devices, or a combination of these. User interaction elements 1403 represent computing devices and/or programs, such as user interfaces, that may be viewable to a user, such as user device 1405. User device 1405 can be any device such as a desktop computer, tablet, mobile device or similar device that maintains functionality for accessing the internet or another type of network, facilitating user input, as well as a user interface.

The user interaction elements 1403 also include a user-submitted data transfer mechanism 1407. The user may manipulate the user device 1405 to upload user data 1409 to an intake module 1411. The user data 1409 may include documents or other types of data. The user-submitted data transfer mechanism 1407 may comprise various protocols for transferring data over the internet such as HTTP, FTP, SFTP or other protocols. The user data 1409 may include a demand letter document such as demand letter 301 of FIG. 3, data from the user input form 203 of FIG. 2, data from the data input section 205 of FIG. 2, and/or data from the payment data section 207 of FIG. 2. The intake module 1411 takes as inputs data which may originate from sources such as those depicted in 101, 103, 105, 107, 109, 201 and 301 of corresponding FIGS. 1, 2, and 3. The intake module 1411 may possess functionality to evaluate which report types are possible based on information in the user data 1409 and external data sources, such as the report types 1301, 1303, and 1323 discussed in relation to FIG. 13. The intake module 1411 may be capable of determining whether payment processing is successful. The intake module 1411 may be configured to transfer user data 1409 to an analysis module 1415 via an intake module to analysis module data transfer 1413. The intake module to analysis module data transfer 1413 may execute via various protocols for transferring data over the internet such as HTTP, FTP, SFTP, or other protocols.

The analysis module 1415 may receive the user data 1409 from the intake module 1411 and may then perform a variety of functions. The analysis module 1415 may receive a template selection from the intake module 1411. The analysis module 1415 uses the user data 1409 as well as the selected template to query one or more data sources 1425, 1427, and 1429. The analysis module 1415 runs a series of calculations and/or algorithms on the data retrieved from the various data sources 1425, 1427, 1429. The analysis module 1415 then sends the calculated and/or combined data to a presentation module 1419. The analysis module 1415 may use a template 1423 as a basis for generating a report that utilizes the user data 1409. The template 1423 may be a pre-configured blank report that is to be filled in with information from the user data 1409 as well as external data from data sources 1425, 1427, and 1429. In one embodiment, a template 1423 may comprise a linked Microsoft Excel™ file and Microsoft Word™ document. An analyst may take data from the user data 1409 as well as external data from the data sources 1425, 1427, and 1429 and transfer it into various fields in the Excel file. The Excel file may contain various calculated cells that update when information is entered into the various aforementioned fields. These calculated cells may be linked to the accompanying Word document and updated accordingly. While one template is depicted and described in the previous example, multiple templates may exist from which one or more templates may be chosen as a basis for generating a report. The multiple templates may have substantially different or similar fields, calculations, or formats, for example.

As mentioned above, the analysis module 1415 may utilize external data from data sources 1425, 1427, and 1429 to generate a report. The first data source 1425 and the second data source 1427 may be the data sources 801 and/or 803 as described in relation to FIG. 8. While the data sources 1425 and 1427 are pictured within the internal system 1401, it should be understood that the data sources 1425 and 1427 may be independent data sources maintained by a third party that exist outside of the internal system 1401, and may be accessed to bring in external data into the internal system 1401. The analysis module 1415 may also utilize one or more internal data sources 1429. An internal data source 1429 may be maintained within the system 1401 and may not be an independent data source maintained by a third party. The internal data source 1429 may take the form of a query-able database. For example, the internal data source 1429 may comprise a database containing all of the claim text for every patent. Certain functions may be performed on these claim texts in the internal data source 1429 that may not be available from external data sources such as data sources 1425 and 1427. Examples of functions that may be performed on data in the internal data source 1429 may include word count on the claims, or locating specific mention of claim text in court documents such as an order of infringement or validity.

The analysis module 1415 may query and retrieve data from the data sources 1425, 1427, and 1429 via a data source to analysis module data transfer 1431, and/or via various protocols for transferring data over the internet such as HTTP, FTP, SFTP or other protocols.

The analysis module 1415 may transfer data via an analysis module to presentation module data transfer 1417 to a presentation module 1419. The analysis module to presentation module data transfer 1417 may execute via various protocols for transferring data over the internet such as HTTP, FTP, SFTP or other protocols.

The presentation module 1419 may take the data received via the analysis module to presentation module data transfer 1417, and render the received data in the form of a report in a web browser or application interface, an electronic document, or some other means for displaying data. The presentation module 1419 may incorporate various rules for rendering the data in the form of a report, but generally does not alter the data itself that is received from the analysis module 1415, other than how the data is displayed. The presentation module 1419 may then transfer the data in the form of a report via a presentation module to user device data transfer 1421 to the user device 1405. The presentation module to user device data transfer 1421 may execute via various protocols for transferring data over the internet such as HTTP, FTP, SFTP or other protocols. The user device 1405 may not necessarily be the same device or address as the user device 1405 that user data 1409 were entered, but may instead be another user device.

Also pictured in the internal elements 1401 is server 1433, which may take the form of a cloud server or other type of server. The server 1433 is representative of a platform for resources. The platform abstracts underlying functionality of hardware (e.g., servers) and software resources of the server 1433. The resources may include applications and/or data that can be utilized while computer processing is executed on servers that are remote from client computing devices, such as user device 1405. Resources can also include services provided over the Internet and/or through a subscriber network, such as a cellular or Wi-Fi network.

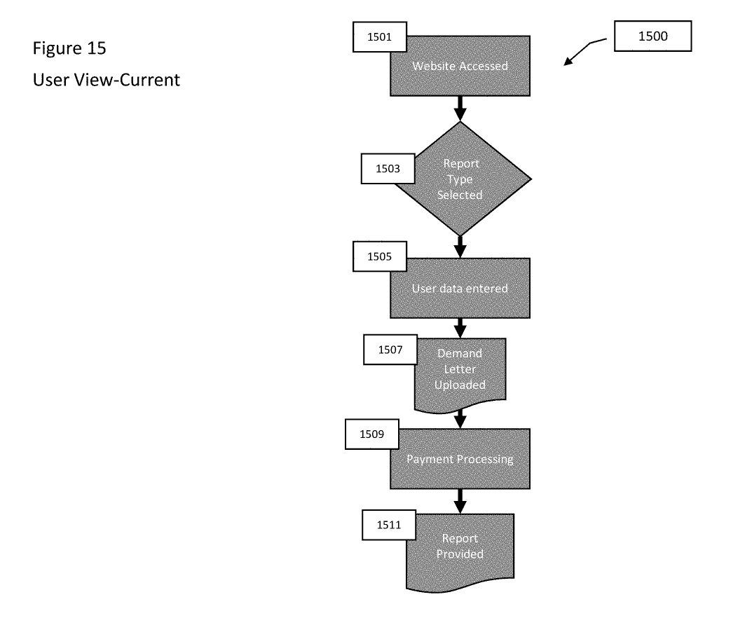

FIG. 15 depicts a process 1500 of an example user experience interacting with a service for generating demand letter forecasting reports in accordance with one or more implementations. At 1501, a website or application for requesting a demand letter forecasting report is accessed by a user. For example, the user can use a web browser to navigate to a specific website (referred to in reference to the process 1500 as “the website”). In some implementations, the website or application may also be accessed via API or other machine interface.

At 1503, a report type is selected by the user. For example, the website will render for the user a set of multiple report types to choose from. The user will then select which report type the user wishes to have generated from the multiple report types. In one example, there may be two report types, such as Express and Premier. There may be “radio buttons” allowing the user to select which report the user wishes to have generated. Alternatively or additionally, there may be check boxes for the user to select multiple types of reports to be generated, or there may be check boxes which enable the user to select sections to be included in a “customized” report. There may be accompanying descriptions, figures, graphics, or samples of each report to inform the user about the different report types.

At 1505, the user enters data for use in generating a report. For example, the user may provide user data to the website, such as through the use of an electronic form. The user data may include data such as the user's name or company name, address, data about the patent dispute, or other data. In one example, the user data will be entered in text entry fields such as those displayed in FIGS. 1 and 2. In another example, the user data may be provided via an API. In yet another example, a user may have an account or user identity saved within the web site. Logging into this account may cause the system to enter and/or render pre-saved user data.

At 1507, a demand letter is uploaded. For example, the user may upload a document to the website. The demand letter may be uploaded via http, https, FTP or some other transfer protocol. The demand letter may be a Microsoft Word™ document, PDF document, GIF, PNG, or some other picture type or electronic document type.

Alternatively or additionally, uploading the demand letter may comprise entering, such as by text-entry field or via API, a series of data entries that substitute for a demand letter document. For example, if the relevant fields extracted from the demand letter are patent number, adversary company name, and date, then providing these data fields directly in text entry boxes, for instance, would serve as an alternative to uploading a demand letter. These data fields may be entered via a user interface or API.

At 1509, payment processing is executed by the user. Payment processing may be done through the website or may be done through a third-party payment processing website such as PayPal™ or Stripe™. In one example, the user is transferred to an associated PayPal™ web page. The user is prompted to select a payment type. The user may be prompted to enter credit-card information and identification information such as name, address, and social security number, or a password. The user may be prompted to confirm a payment amount. Once payment processing is complete, a notification is sent to the website indicating that payment has been confirmed. The website then may send a notification to the user, possibly rendered on the website, that the order has been confirmed and that they will receive their report in a certain amount of time.

At 1511, the report is provided to the user. For example, after some period of time, the user will receive either a physical or electronic copy of the report, or both a physical and electronic copy of the report. The user may receive an access location and credentials to access an online version of the report. Alternatively or additionally, the user may receive any or all of these via a provided email address, via physical mail, phone call, text message, or some other messaging service in order to access the report.

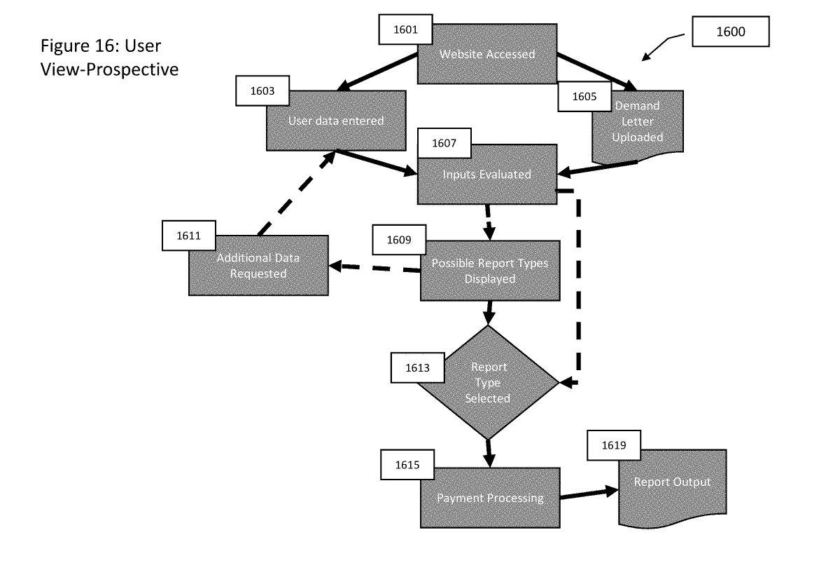

FIG. 16 depicts an additional process of an example user experience interacting with a service for generating demand letter forecasting reports in accordance with one or more implementations. At 1601, a website or application is accessed, similar to the discussion of step 1501 of FIG. 15. At 1603, user data is entered. When the user data is entered, certain fields may be present or absent based on what data is requested and/or what data is required to complete a request for generating a report. For example, the user may fill out some, but not all, of the fields presented in a first iteration of user data entry. However, the user may select a report type that requires data not yet received by the system such as via user data entry or included in an uploaded demand letter. In this case, additional required data fields for the particular selected report type are shown to the user for completion. Previously completed data fields may or may not be displayed at this time. Alternatively or additionally, a rubric or list of required data to “unlock” different report types may be viewable to the user when the user is entering data.

A demand letter is uploaded at 1605. The demand letter may be uploaded in accordance with the discussion of 1507 of FIG. 15. The demand letter may be uploaded before, after, or at the same time as the user data is entered.

The two inputs, including the uploaded demand letter and the user data, are evaluated at 1607. Both the user data and the demand letter may be analyzed, and a computing system determines what data can be extracted from the combination of the two inputs. The data from the two inputs is then evaluated to determine possible report types that can be generated from the data. The data from the two inputs may be compared against a rubric or series of rubrics to determine which report types are possible. For example, an Express report may only require an adversary company name and patent number, whereas a Premier report may require a patent number, date field, dollar amount demanded, and law firm name. A list of required-but-absent data may be generated for each report type. The rubric(s) may be viewable to the user.

A list of possible report types may be displayed, sent, or otherwise output to the user at 1609. For example, there may be a display allowing the user to select from currently available report types or currently unavailable report types. The currently unavailable report types may be based on information that is required for the unavailable report types but has not yet been entered by the user.

At 1611, additional data is requested from the user. Additional data may be user data or data extracted from a demand letter. If a report type is unavailable with the current data received from the two inputs, the user may be directed back to step 1603 and prompted to enter in additional information. Although it is not explicitly shown in the process 1600, the user may be prompted to upload another demand letter or alternative document that may provide additional inputs. A rubric or list of which data is required to unlock different report types may be viewable to the user.

At 1613, a report type is selected. The report type may be one of multiple report types that are selectable. The report type may be selected by the user or a selection process implemented by a computing system. In the case of the selection process implemented by a computing system, the user may be shown a notification of which type of report was selected. The selection process implemented by the computing system may select a report type based on what information has been provided, or may select a report based on a preliminary analysis of a level of risk of the demand letter, to name a few examples. When the report is selected, the user is forwarded onto payment processing at 1615. Payment processing may be in accordance with the payment processing step 1507 of FIG. 15. When the report is completed, the report is output to the user at 1619. Outputting the report may be in accordance with step 1511 of FIG. 15.

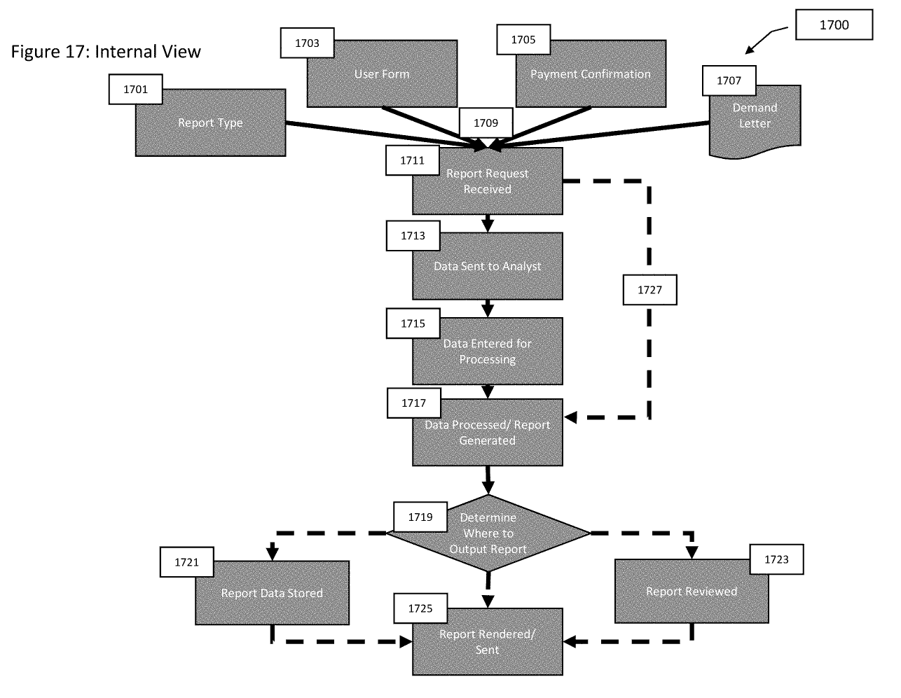

FIG. 17 depicts an example process 1700 for generating demand letter forecasting reports in accordance with one or more implementations. To generate a demand letter forecasting report, several types of information may be gathered. A first type of information that may be gathered to generate a demand letter forecasting report may be the report type 1701, which contains pre-defined instructions for data processing, and may be chosen as described in relation to FIGS. 15 and 16.

Another type of information that may be gathered to generate a demand letter forecasting report is a user form 1703. The user form 1703 may contain user data, such as user data 1505 and 1603 described in relation to FIGS. 15 and 16. The user form 1703 may take an appearance as depicted in FIGS. 1 and 2.

Another type of information that may be gathered to generate a demand letter forecasting report is payment confirmation 1705. This may be the result of payment processing steps as described in 1509 and 1615 of FIGS. 15 and 16, or some other means for payment confirmation.

Another type of information that may be gathered to generate a demand letter forecasting report is a demand letter 1707. This may be a demand letter or demand letter equivalent that has been uploaded as described in relation to the steps 1507 and 1605 of FIGS. 15 and 16.

At 1709, data from the various information types 1701-1707 is sent, transferred, and/or delivered to a database and/or computation environment for processing. This may be done via a combination of http, https, FTP or some other file transfer protocol.

At 1711, a request for a report is received. When information required to generate a report is received, such as information contained in information types 1701-1707, a report request may be considered complete. Lacking an item of required information may prohibit a request for a report from taking place, although embodiments are considered where requests for reports may be made without items of information present. For example, requests may be made for more data or information, such as described in relation to FIG. 16, or reminders may be sent to a requester to complete missing items of information.

At 1713, data is sent to an analyst. For example, the request for a report received at 1711, along with data from information types 1701-1711, is sent to an analyst, analyzation device, or account associated with an analyst. This may be through a medium such as email, regular mail, messaging service, or some other communication medium. In one implementation, the analyst may then be “responsible” for the report's completion at this time.

At 1715, data from the different information types 1701-1707 are entered for processing. For example, the analyst may enter the data into one system or a variety of systems for processing. This may include the aforementioned sections (e.g., the section 701 of FIG. 7) and/or report types (e.g., the report type document 1101 of FIG. 11). In one example, the analyst has access to a specific data entry program or application to use in entering the data, or may use a program such as Microsoft Excel™ to enter the data in respective fields for processing.

At 1717, the data that was entered is processed, and a report is generated based on the entered data. The entered data may undergo processing in accordance with the section parameters and report type. As stated throughout, each section may be generated using pre-programmed data processing tasks. The report can then be generated by compiling the constituent sections and adding any additional required elements, such as title pages, appendices or other auxiliary elements. In some implementations, generating the report may require human analyst manipulation and/or analyst input. Generating the report may even require an analyst to render an opinion or provide interpretations of data inputs or results. In one example, an analyst may annotate a graphic in the report to highlight important data. In another example, an analyst may provide an explanation in the report of an anomaly in the data or the results. In yet another example, an analyst may correct data or results that the analyst deems incorrect or misleading, or for some other reason.

The analyst may use a series of programs to facilitate analysis. In one example the analyst may enter data into Microsoft Excel™ templates that correspond to the sections dictated by the chosen report type. Those Excel templates may contain pre-programmed calculations and fields that analyze the data, convert it, perform calculations on it, and/or use it to generate or alter a graphic. These Excel templates may be linked to a presentation or electronic document program such as Microsoft PowerPoint™ or Microsoft Word™ Presentation and electronic document programs may also contain templates corresponding to the sections. These templates may be for the purposes of presentation rather than analysis and may work in conjunction with the templates regarding the linked Excel program. While Microsoft Excel™, PowerPoint™, and Word™ are used as examples, other programs may be used to facilitate analysis and generate presentation of the report.

Alternatively or additionally, some or all of the functions performed by the analyst may be performed by programs of one or more computing devices. These functions may be programmed alongside or within the aforementioned “pre-programming” Alternatively, programs may exist that are one hierarchical step above the section-based “pre-programming” These programs may evaluate the results of a section, or results of a combination of sections of the report. These programs may perform “meta-analysis” of all or part of the sections to evaluate and/or correct for consistency, accuracy, and other quality metrics. Proof-reading algorithms may be employed as part of the programs. There may be programs that flag suspicious or incorrect data or results for review by an analyst. These programs may incorporate data from other reports and may utilize machine-learning functionality. In one example, an algorithm tracks how often a calculated field has a value over 100. After reviewing numerous reports, the algorithm determines that less than 2% of all reports contain a value over 100 for this field. The algorithm may flag any future report with a value over 100 for further review by an analyst. After more reports are processed, the algorithm may revise its flagging functionality according to some criteria.

When the report is completed, a determination is made as to whether the report is output to storage, output to the requestor of the report, and/or output to a reviewing analyst or program at 1719. Outputting the report may be done via http, https, FTP or some other transfer protocol. A report need not be output in its entirety, for instance, portions of a report may be sent. Metadata about a report may also be output, such as the responsible analyst, date of completion, data of data extraction, calculation errors, flags, or other metadata that may not necessarily be present in the actual report.

Based on the determination at 1719, report data may be stored at 1721. Reporting data, including data within a report as well as metadata may be stored in an electronic storage medium, such as a database.

Based on the determination at 1719, the report may be reviewed at 1723. A report and/or report metadata may be presented to an analyst or reviewing algorithm for review. A review may include proof reading, error handling, value verification, comparison to other reports/benchmarks and other general review tasks. An analyst or reviewing program may provide verification that a report has been reviewed. The verification may be individualized and metadata may be kept about verification.

Based on the determination at 1719, the report may be sent to the requestor of the report at 1725, such as by the techniques described in step 1511 of FIG. 15. Additionally, data or information about a report review generated as a result of step 1723, and/or data from a data stored as a result of step 1721, may be sent to a requestor of the report. In one example, there may be a “Reviewer's comments and verification” report sent along with the requested report. In another example, aggregate report data from a report data store may be sent, such as “this is the 1,000th report sent” or other metric that may be of interest to the requestor of the report.

In an alternative embodiment, steps 1713-1715 may be fully automated, as indicated by 1727. For example, the analyst functions may be partially or totally bypassed and a report may be generated completely by programs of one or more computing devices. In one example, if all data types fit some criteria, such as easily calculable, no outliers, user request, or some other criterion, the report generation bypasses a human analyst and is directly generated by programs of one or more computing devices. Data from information types 1701-1707, as well as a report request 1711, may be directly passed to data processing and report generation 1717. Specific metadata may result indicating functions performed by one or more computing devices, and such metadata may be associated with the generated report.

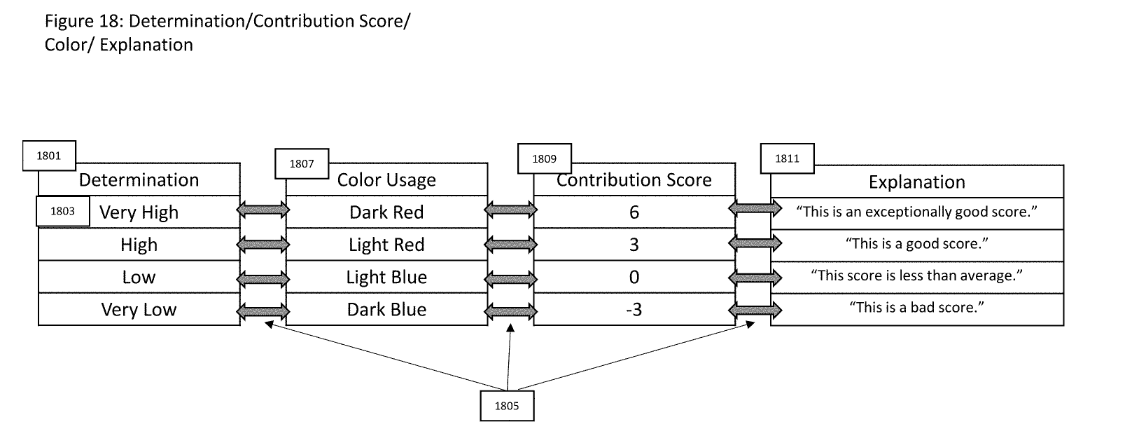

FIG. 18 depicts examples of metrics that may be used to describe contents of a demand letter forecasting report, such as how determinations, contributions, scores, colors, and/or explanations may coordinate or be associated with one another. In one or more embodiments, a determination list 1801 comprises a list of possible determinations that may occur in sections of a demand letter forecasting report. Determinations that occur within a section are based on corresponding user data or input data and/or information extracted from a demand letter. The user data or input data and information extracted from the demand letter are analyzed according to the specific section, and may include analysis using external data as well. Determinations in the determination list 1801 may be discrete (as shown), or may be continuous, such as a dollar amounts in a range. The determination list may include specific determinations 1803, such as “Very High” for example. The specific determinations 1803 correspond to the determinations found in the sections of the report that are based on user data, input data, data extracted from the demand letter, and/or external data.

A specific determination 1803 or specific range in the case of a continuously measured determination, may have one or more associations 1805 with a specific color usage (or range of colors), a contribution score, and/or a specific explanation. When a specific determination 1803 is made in generating a report, the specific determination 1803 is used with the determination's associations 1805 such as color, contribution score, and explanation to populate a rendering of a report, such as by populating components 605, 609, 611, and 613 of FIG. 6. Further, a contribution score having an association 1805 to a specific determination 1803 may be used to calculate a composite score, such as the composite score 1001 of FIG. 10.

A specific determination 1803 may have an association 1805 with a color designation, which may be part of a color usage designation list 1807. The color usage designation may be arranged or selected in a way that can add additional informational or entertaining considerations to the report. The color usage designation list 1807 may be a list of colors or a range of colors. For example, a user may associate, or be prompted to associate “warm” colors such as red as good and “cold” colors such as blue as “bad” within the context of a report. A section containing warm colors may be of additional interest to the user and they may be drawn to that section by the color usage. The color usage designation list 1807 may include color choices as a function of intensity. For example, an extreme determination may correspond to comparatively bright colors when compared to colors corresponding to less extreme determinations. The examples of colors provided herein are only examples, and it should be readily understood that any color combinations may be associated with determinations.

The color usage designations in the color usage designation list 1807 may manifest in various ways in renderings of the sections/reports. Certain text may be shown as a specific color corresponding a specific color usage designation from the color usage designation list 1807. Additionally, shapes or components of graphics and table entries may displayed based on a specific color usage designation from the color usage designation list 1807 as well.

A specific determination 1803 may have an association 1805 with a contribution score, which may be part of a contribution score list 1809. The contribution score list 1809 may include numeric or non-numeric values, and may include positive and negative numeric values. Additional description of contribution scores may be found in the discussion of FIGS. 10 and 12.

A specific determination 1803 may have an association 1805 with an explanation, which may be included as part of an explanation list 1811. The explanation list 1811 may contain words, series of words, or entire sentences that correspond to a list of determinations. The explanation list 1811 may also contain rules for altering a word template. For example, a word template might contain, “This patent has a ______ likelihood of validity. This is ______ for you if you plan to litigate against this patent.” Based on information gathered when generating a report, a determination of patent validity of 90% is found for a patent. This determination may have an association 1805 to an explanation in an explanation list 1811 of “high, bad.” When the explanation is applied to the template it now reads, “This patent has a high likelihood of validity. This is bad for you if you plan to litigate against this patent.” Alternatively or additionally, entire sentences or even paragraphs may be inserted into a word template from an explanation list 1811 based on a particular determination.

FIG. 19 depicts a rendering 1900 of a section as an additional example to the sections rendered in FIG. 5 and FIG. 6. The rendering 1900 of FIG. 19 is for example purposes and not meant to be limiting. The rendering 1900 is of a demand letter checklist 1901 also described above. The rendering 1900 shows a series of possible determinations 1903 with corresponding colors as previously described in relation to FIG. 18. The rendering 1900 shows a determination 1905 which may be depicted in multiple locations of the rendering. The determination 1905 may include an indication of one of a series of possible determinations 1903 at one of the multiple locations, depicted here as a white triangle. The rendering 1900 also depicts a first explanation 1906(a) with a background color at another location indicating the determination 1905. The first explanation 1906(a) is shown with a background color that is part of a color scheme assigned to possible corresponding determinations. A second explanation 1906(b) with a same background color as the first explanation 1906(a) is depicted in the rendering 1900, having an accompanying score metric. If the determination 1905 were of a different category (e.g., “Strong” instead of “Weak”) the three locations described as part of the determination 1905 would be the color associated with the different determination (e.g., orange instead of green).

The rendering 1900 shows a checklist table 1907. The checklist table 1907 shows various categories 1909 that may describe a real or example demand letter. The checklist table 1907 also shows a status column 1911 which shows the results of analysis performed on a demand letter, such as in accordance with the description of the demand letter 1707 of FIG. 17. The results of analysis may affect the coloring of the background of the individual cells in which the result of an analysis resides, such as the status column 1911 and a points column 1913. The checklist table 1907 also shows the points column 1913 which indicates the contribution that each row in the status column 1911 contributes to the determination 1905. An explanation column 1915 is also contemplated. Information provided in the explanation column 1915 may correspond to the description of explanation(s) 713 of FIG. 7. Certain results appearing in the status column 1911 may correspond to particular explanations (e.g., “Yes” corresponds to the explanation “Increases Credibility”) that are consistent throughout the checklist table 1907. Additionally or alternatively, results appearing in the status column 1911 and the points column 1913 may be grouped together for purposes of a combined explanation in the explanation column 1915. (e.g., the cell starting with, “Each of these . . . ”). In some cases, various categories 1909 may correspond to unique explanations in the explanation column 1915.

The above content of this application generally relates to reports concerning demand letters as described in Provisional Patent Application 62/400,236. The following content incorporates the entirety of the above content and expands upon it, particularly regarding reports concerning complaints and other filings, report templates, and report generation procedures.

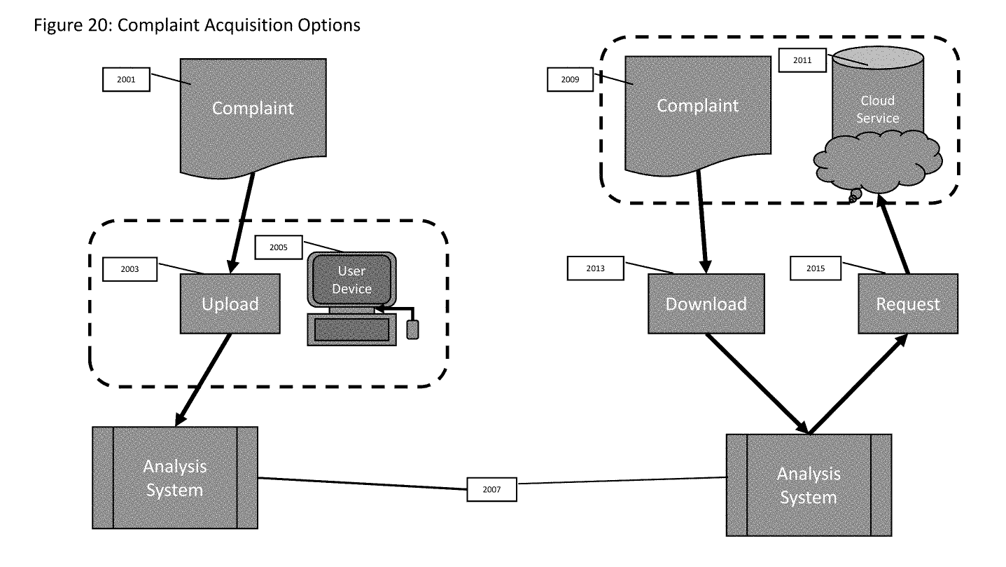

FIG. 20 generally depicts an example of two potential analysis systems configured to acquire information about a complaint. A complaint 2001 is a formal legal document that sets out the facts and legal reasons that the filing party or parties believes are sufficient to support a claim against the party or parties against whom the claim is brought. Other types of legal documents are also contemplated which may be analyzed by the described systems, including but not limited to amendments or amended complaints, answers, amended answers, counterclaims, amended counterclaims, cross-claims, petitions (such as to the Patent Trial and Appeal Board), responses, initiating documents (such as those filed with the Federal Trade Commission), enforcement proceedings, advisory opinions, and the like. In one example, a complaint is served to a party. A party refers to a party-to-litigation which may include individuals, companies, governments, or any other legal entity allowed to engage in the legal system. That party (or that party's representative) may then, by use of a user device 2005, upload 2003 the complaint to an analysis system 2007. The user device 2005 may be any type of electronic device such as a computer, tablet, phone or other device with memory and access to a network. In one example, the complaint 2001 may be loaded onto the user device 2005 by a scanner. In another implementation, specific information from the complaint 2001 such as party names, dates, pleadings, or any other information found in the complaint may be typed into the user device 2005. The user device 2005 may then send the complaint 2001, or complaint-related-data, to an analysis system 2007 by use of a network such as the Internet. The analysis system 2007 may be analogous to the system described in FIG. 8, internal elements 1401 from FIG. 14, and/or the procedure 1700 described in relation to FIG. 17.

In another example, a complaint 2009 may exist in electronic form within a cloud service 2011 that stores complaints. An example of a cloud service is Docket Navigator™ and may include all previous references to a database service, research database service, searchable research database service, or analysis database service. The analysis system 2007 may send a request 2015 to the cloud service 2011 to access the complaint 2009. This request 2015 may comprise various protocols for transferring data over the Internet such as HTTP, FTP, SFTP or other protocols. The request 2015 may also comprise an API call. In response to the request 2015, the analysis system 2007 downloads 2013 the complaint via a network. In the environment thus described, a complaint 2009 may be acquired by an analysis system automatically and without input from a user.

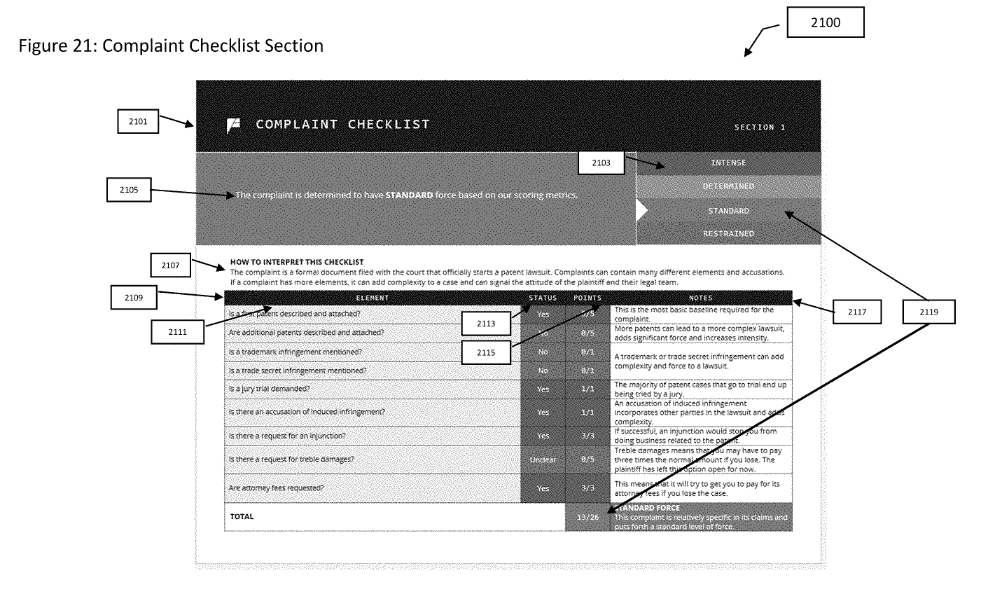

FIG. 21 generally depicts an example of a section 2100 which may be included in a forecasting report. The section 2100 may contain a header 2101 which may further contain titles, section numbers, dates, icons, disclaimers, notes, or other general or reference information. The section 2100 may contain a determination 2103 analogous to the determination described in item 611 of FIG. 6. The section 2100 may contain an explanation of a determination 2105 analogous to the explanation described in relation to the explanations 713 of FIG. 7. The section 2100 may contain other explanatory text 2107. The section may contain a table 2109. In the illustrative example shown, the table 2109 is in the form of a checklist whereby certain elements common to legal complaints are displayed in an elements column 2111. The table 2109 may also contain a status column 2113 which displays the results determined for a particular complaint. In the example shown, the status column may display results as “yes” or “no” but other implementations are also contemplated such as numerical or iconographic results. The table 2109 may also contain a points column 2115. The points column 2115 may indicate the relative importance or impact on a final score or determination 2103 of different elements. For example, an accusation of induced infringement may not alter the process of a patent litigation as much as a request for treble damages. This discrepancy may be indicated by a different point total in the points column 2115.

The table 2109 may also contain a notes column 2117. The notes column 2117 may contain explanations of the elements column 2111, the status column 2113, and/or the points column 2115. The contents of each cell in the notes column 2117 may or may not be dependent on the corresponding result in the status section. The table 2109 may also contain a determination 2119. The determination 2119 may be based on the results of the points column 2115.

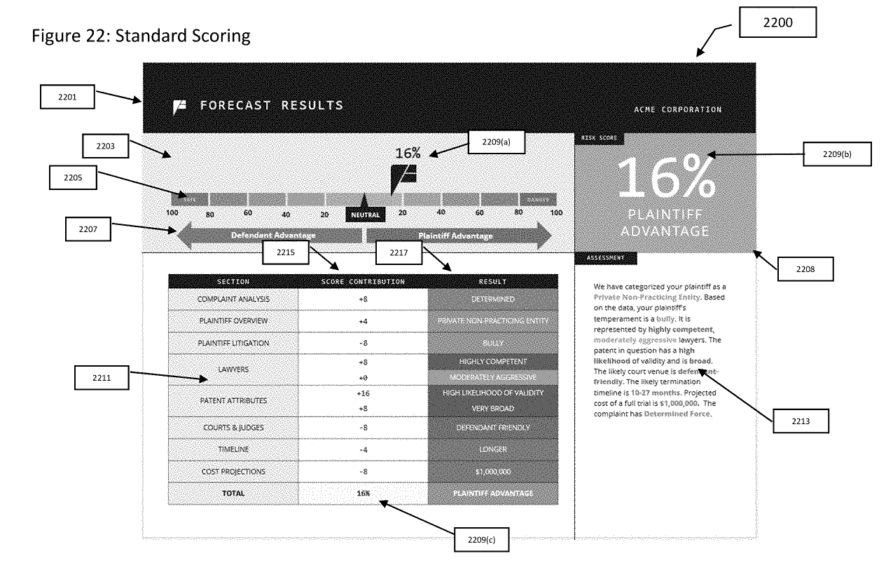

FIG. 22 generally depicts an example of a results section 2200 of a forecast report. The results section 2200 may contain a header 2201 which may contain titles, section numbers, dates, icons, disclaimers, notes, or other general or reference information.

The results section 2200 may contain a results graphic 2203. The results graphic 2203 may take the form of a range of color boxes 2205. The color boxes 2205 may extend from a central point to outer extremes. Certain colors may be associated with a central or moderate position while other colors may be associated with outside or extreme positions. In one illustrative example, bright red may indicate high favorability for the plaintiff while bright blue may indicate high favorability for the defendant. The color boxes 2205 may also have labeled axes and indications of the central point, outermost points, and/or intermediate points. Also contemplated (though not pictured) is a fuel gauge rendering of a results graphic 2203. The fuel gauge rendering may be similar to the color boxes 2205 in use of color, central point, outer extremes and labels.

The results graphic 2203 may also contain orientation indicators 2207 which may use a combination of shapes, colors, numbers and/or words to explain the directional axes and scale of the results graphic 2203. The results section 2200 may also contain a final determination 2208 corresponding to the final determination 1009 in FIG. 10. In the results section 2200, an indicator icon 2209(a) is used within the results graphic to signal the where the final determination 2208 exists on a range or continuum.

The final determination 2208 may manifest in several positions and displayed via different means simultaneously. In the example shown, the final determination 2208 is manifest as the indicator icon 2209(a) with a label, a separate determination box 2209(b), and in addition as a final row 2209(c) of a determinations table 2211. A results section may also contain a determinations table 2211 which may be similar to the graphic 1003 of FIG. 10.

Also contemplated as part of the determinations table 2211 are columns for each row and/or section, each section's score contribution 2215, and each section's result 2217 whereby different result possibilities correspond to score contribution 2215 numbers. A score contribution 2215 may correspond to the section 707 in FIG. 7. A score contribution 2215 may be subject to a weighting schema. In one example, the score contribution 2215 numbers can be positive or negative values depending on their perceived benefit to either the plaintiff or the defendant. The magnitude of a particular result within a weighting schema may be the result of a predetermined logic, the logic being informed by the relative importance or impact of different results. For example, a longer predicted timeline may not alter the process of a patent litigation as much as the validity of a patent. This discrepancy may be indicated by a different point total in the score contribution 2215 results.

The score contribution 2215 and/or a weighting schema used to derive the score contribution numbers can be modified or updated. In one illustrative example, an audit of the score contribution 2215 and/or weighting schema may be performed by a panel of experienced patent litigators. The patent litigators may decide that different values should be applied to various score contribution 2215 numbers based on the relative importance of the various score contributions 2215. In another alternative example, report data may be stored corresponding to report data 1721 of FIG. 17. Analysis may be performed on this report data 1721, such as comparing a determination 2208 to a particular outcome in litigation, such as a plaintiff win. In response to the analysis, score contribution 2215 numbers and/or weighting schema may be changed such as adding weight to a score contribution 2215 that is consistently associated with a win for plaintiffs.

Table 1 is provided below for illustrative example of score contribution 2215 numbers, and how a score contribution may relate to a determination 2208. These score contribution 2215 numbers are meant only as examples of possible values, and any values are contemplated to be used in relation to a determination 2208.

| | Complaint Analysis Determinations | | | |
|---|---|---|---|---|
| Determination | Restrained | Standard | Determined | Intense |
| Score | −8 | −4 | 4 | 8 |
| Contribution | | | | |

| | Plaintiff Overview Determination | | | | |
|---|---|---|---|---|---|
| | | Private | | Private | |
| Determination | Individual | Op | Public Op | NPE | Public NPE |
| Score | −4 | −2 | 0 | 2 | 4 |
| Contribution | | | | | |

Plaintiff Litigation Determination

| Determination | Pacifist | Bully | Bear | Brawler |
|---|---|---|---|---|
| Score | −8 | −4 | 4 | 8 |
| Contribution | | | | |

| | Lawyer Competence Determination | | |
|---|---|---|---|
| | Low | | |
| Determination | Competence | Moderate Competence | High Competence |
| Score | −4 | 0 | 4 |
| Contribution | | | |
| | Lawyer Aggression Determination | | |
| | Low | | |
| Determination | Aggression | Moderate Aggression | High Aggression |
| Score | −4 | 0 | 4 |
| Contribution | | | |

| | Patent Validity Determination | | | | |
|---|---|---|---|---|---|
| | Likely | | In- | Likely | High |
| Determination | Invalid | Questionable | conclusive | Valid | Likelihood |
| Score | −8 | −4 | 0 | 4 | 8 |
| Contribution | | | | | |

| | Patent Breadth Determination | | | |
|---|---|---|---|---|
| Determination | Very Narrow | Narrow | Broad | Very Broad |
| Score | −4 | −2 | 2 | 4 |
| Contribution | | | | |

| | Courts & Judges Determination | | |
|---|---|---|---|
| Determination | Defendant Friendly | Neutral | Plaintiff Friendly |
| Score | −4 | 0 | 4 |
| Contribution | | | |

| | Timeline Determination | | |
|---|---|---|---|
| Determination | Longer | Typical | Shorter |
| Score | −2 | 0 | 2 |
| Contribution | | | |

| | Cost Projections Determination | | |
|---|---|---|---|
| Determination | Less | Average | More |
| Score | −4 | 0 | 4 |
| Contribution | | | |

A forecast assessment explanation 2213 is also contemplated. A forecast assessment explanation 2213 may correspond to the text description 1005, the section determinations 1007, and the final determination 1009 described in relation in FIG. 10.

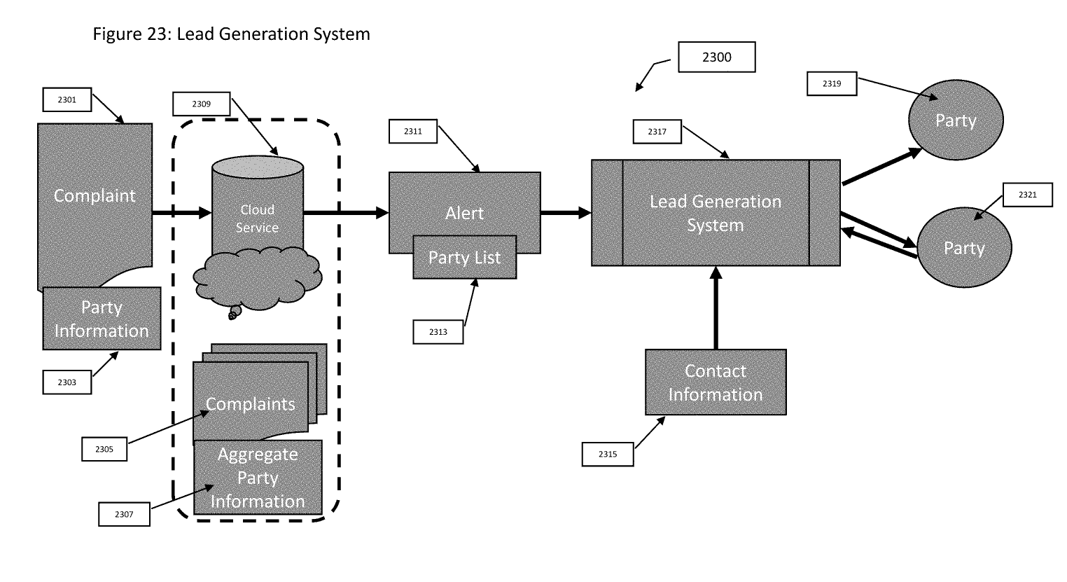

FIG. 23 illustrates an example system 2300 for the generation of sales leads in response to a legal complaint. A legal complaint 2301 corresponding to the complaint 2001 of FIG. 20 is filed with a court. The complaint 2301 may contain party information 2303 as well as other information. Party information 2303 may comprise information associated with one or more parties such as party names, employee names, employee titles, email addresses, phone numbers, physical addresses, legal representatives, country affiliation, or other information or some combination of the aforementioned information types. Party information 2303 may be explicitly stated in the complaint but may also be inferred or derived from information provided in the complaint. Party information can also be obtained from other sources such as online databases or other online resources.

A cloud service 2309 may possess a database of one or more complaints 2305, information extracted from complaints, and methods of organizing and retrieving both complaints and information extracted from complaints. An example of a cloud service 2309 is Docket Navigator™. The cloud service 2309 may possess functionality to indicate or provide litigation statistics and details for parties, judges, lawyers, cases, filings, dates, and other metrics. The cloud service 2309 may possess aggregate party information 2307 which is comprised of party information 2303 extracted in aggregate over multiple complaints 2301. The aggregate party information 2307 may be indexed for search-ability. The cloud service 2309 may provide alerts 2311 to subscribers of the cloud service 2309. The alerts 2311 may be in the form of email or other form of communication and may be sent in response to the filing of a complaint. Additionally or alternatively, the alerts 2311 may be sent periodically and may contain information pertaining to a number of complaints. In one example, the cloud service 2309 sends a daily email alert 2311 containing information pertaining to all complaints filed on the previous day. The alerts 2311 may contain a party list 2313. The party list 2313 may contain the names of all parties mentioned in one or more complaints over a certain period. Additionally or alternatively, the alerts 2311 may contain a party list informed by different criteria, such as a specific party of interest.

A lead generation system 2317 may be configured to receive the alerts 2311. The lead generation system 2317 may also contain specific logic for opening and parsing the alerts 2311 and accessing information from the alerts. Processes and functionality executed by the lead generation system 2317 may be performed wholly or in part by a computing device. The lead generation system 2317 may also be able to access contact information 2315. Contact information 2315 may comprise email addresses, physical addresses, phone numbers, web addresses, and other information for performing communication with a specific entity or entities. In one example, contact information 2315 may be purchased from a third-party provider such as Hoovers™, Owler™, or other service that provides contact information. In another implementation, contact information 2315 may developed and kept in an internal database. The lead generation system 2317 may possess logic for matching party information 2303 and/or party list information 2313 with contact information 2315. This logic may include techniques such as fuzzy matching. The lead generation system 2317 may also possess logic for identifying and/or correcting missing, incomplete, or incorrect contact information.

The lead generation system 2317 may be configured to send a correspondence to one or more parties 2319 or party representative(s) using the contact information 2315. The correspondence may be an email, phone call, physical mail, text message, or other type of communication or combinations thereof. The correspondence may contain information about the party's legal situation, an invitation to do business with another party, advertisements, notices of future events, coupons or discount information, links to a product or service, direct offers for products or services or other information. Additionally or alternatively, the lead generation system 2317 may be configured to both send and receive correspondence from one or more parties 2321 and/or their respective representatives. Outbound correspondence may include everything described under 2319. Inbound correspondence may include confirmations of the receipt of a correspondence, responses to outbound correspondence, requests for correspondence, corrections to errors in outbound correspondence and the like.

The lead generation system 2317 may contain logic to analyze inbound correspondence form one or more parties 2321 and to perform follow-up correspondence, correction correspondence, or other types of correspondence in response to inbound correspondence.

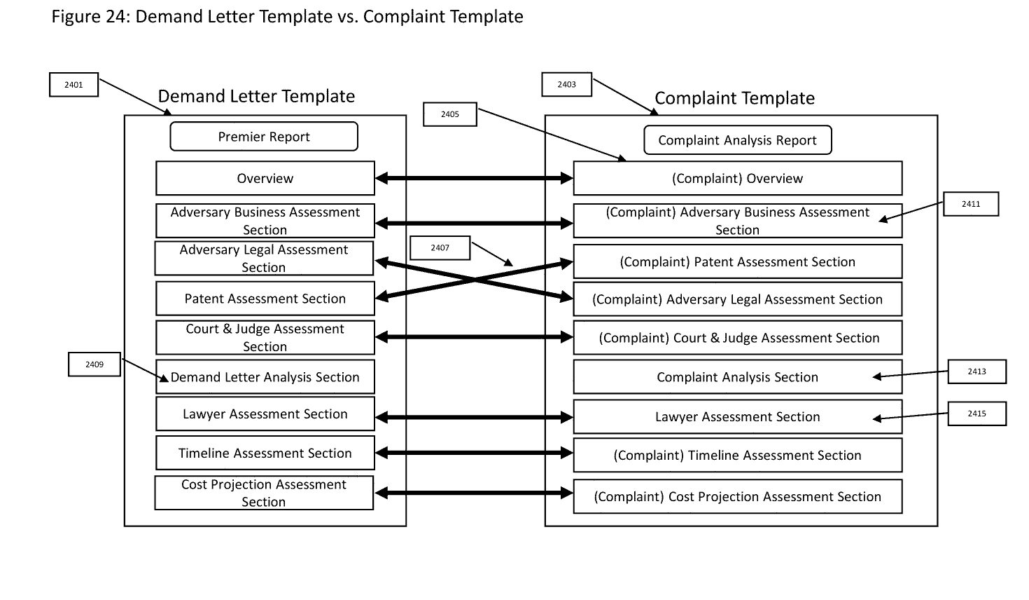

FIG. 24 illustrates two related, but distinct templates of forecasting reports. A demand letter template 2401 may correspond to FIG. 13 and the accompanying description. A complaint template 2403 is also contemplated, which may include the following distinctions from the demand letter template 2401. A complaint template overview 2405 may contain different explanations and formatting which are appropriate for a complaint context rather than a demand-letter context. For example, in the demand letter template 2401, an overview may pertain to the risk of potential litigation. In the complaint template 2403, the overview 2405 may pertain to the relative advantages the plaintiff and defendant, respectively.

The complaint template 2403 may have some sections that are similar to sections described in a demand letter template 2401. A similar section 2411 may incorporate some or all of the same data inputs, graphics, contribution scores, and determinations as a comparable demand letter section. In some cases, a similar section 2411 will have explanations that are different than those in a comparable demand letter template 2401. In one example, a similar section 2411 replaces instances of the words “demand letter” with “complaint.” Other word substitutions are also contemplated, as well as entirely different sentences and sentence combinations to make explanations conform to the different report templates.

The ordering of sections may be different between the demand letter template 2401 and the complaint template 2403 as shown by the crossed arrows 2407. The illustration is just one example, other ordering combinations are also contemplated.

The complaint template 2403 may contain one or more sections not included in a demand letter template 2401. In the example shown, the complaint analysis section 2413 exists only in the complaint template 2403 and not in the demand letter template 2401. The complaint analysis section 2413 may correspond to the complaint checklist section depicted in FIG. 21, and include some or all of the components of the complaint checklist in the section 2100.

The complaint template 2403 may omit sections contained in the demand letter template 2401. An illustrative example is the demand letter analysis section 2409, which is not included in the complaint template 2403.

The complaint template 2403 may contain sections that are the same, or similar to, the demand letter template 2401. An illustrative example is the lawyer assessment section 2415, shown in both the complaint template 2403 and the demand letter template 2401. For example, the legal representation of the plaintiff and analysis thereof including input data, graphics, explanations, contribution scores, and other components of a section may be the same for a demand letter template 2401 as a complaint template 2403.

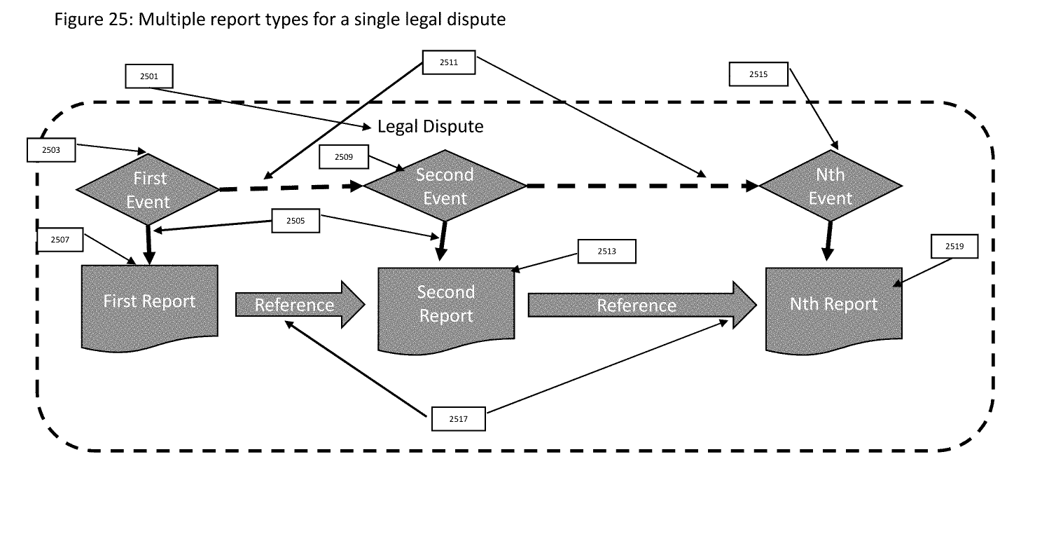

FIG. 25 illustrates a series of events and reports related to a legal dispute 2501. A legal dispute is any dispute that may result in litigation and may incorporate correspondence between the parties to the litigation before the litigation is officially filed. For example, one party may send another party a demand letter or cease-and-desist letter before filing a complaint, the complaint officially initiating litigation. An example legal dispute 2501 would incorporate a demand letter, a cease-and-desist letter, as well as any documents pertaining to the resulting litigation.

A legal dispute 2501 may contain a number of legal events. A first event 2503 may correspond to a demand letter, cease-and-desist letter, other correspondence sent from one party to another, or some other event. Other events are also contemplated including but not limited to a pleading before a district court such as a complaint, report on the filing of action regarding a patent, amended complaint, complaint in intervention, third party complaint, answer, amended answer, counterclaim, amended counterclaim, cross-claim, hearing, judge's decision, jury verdict and the like. Also contemplated are events related to the Patent Trial and Appeal Board (PTAB) such as a petition, patent owner preliminary response, or patent owner response. Also contemplated are events related to the International Trade Commission (ITC) such as an initiating document, enforcement proceeding, or advisory opinion.

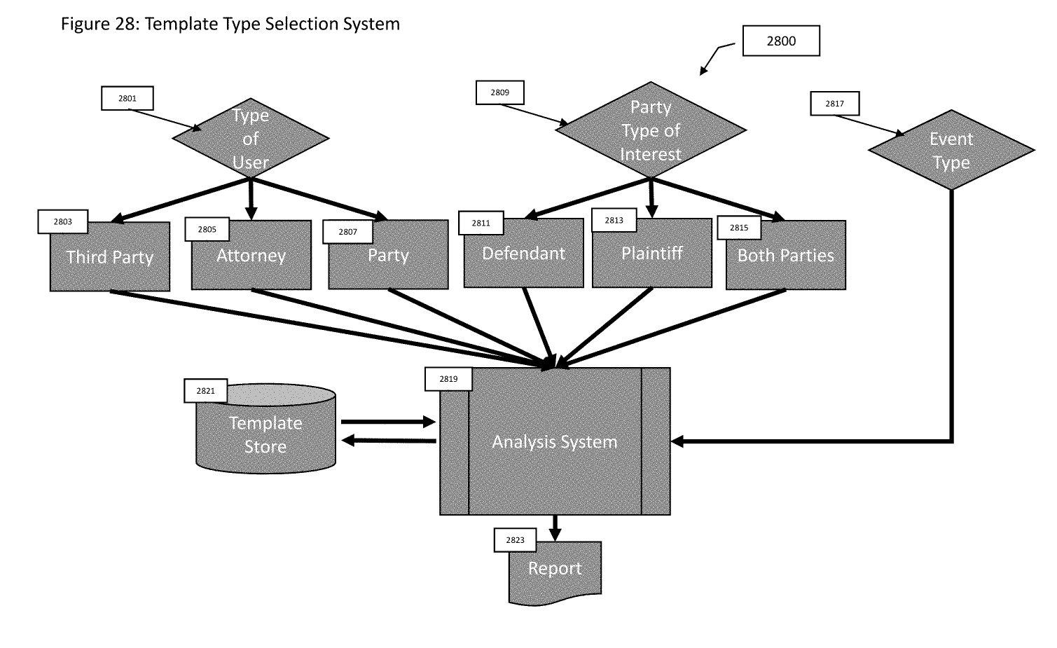

The first event 2503 may trigger generation of a first report 2507. The first report 2507 may comprise information within one or more report templates such as such as the express report described in item 1301 of FIG. 13, premier report such as the premier report described in item 1303 of FIG. 13, the a la carte report described in item 1323 of FIG. 13, complaint report 2403 described in FIG. 24, or other report template. The generation of the first report 2507 may result from an event trigger 2505. An event trigger 2505 may, at minimum, comprise a notification that an event has taken place which may prompt a system to generate a report. In another example, an event trigger may include the process by which a report is generated such as the process described in relation to FIG. 28.

A second event 2509 may occur within the same legal dispute 2501. For example, the first event 2503 may correspond to a cease-and-desist letter. Subsequently, the second event 2509 may correspond to a complaint being filed. These examples are not meant to be limiting and all events described in the first event 2503 may additionally or alternatively, pertain to the second event 2509.

A second report 2513 may correspond to the second event 2509 and may be generated in response to an event trigger 2505.

An event relation 2511 describes the relationship between events within a legal dispute 2501 such as the first event 2503, the second event 2509, or an Nth event 2515 and may occur sequentially, simultaneously, in parallel, or by some other relation. Events may have consequences for related or subsequent events, and these consequences may be communicated by an event relation 2511. For example, a case management conference may outline a date for when a certain type of disclosure must be provided to the court and/or opposing party. A subsequent event may correspond to the receipt of the disclosure. If the receipt of the disclosure has not occurred by the date provided in the case management conference, then the subsequent event may be considered “late.” Statuses such as received, pending, or late may affect subsequent events as well as subsequent analyses of those events. In another example, an event may determine that a patent is valid for this litigation and the remainder of the litigation will focus on infringement. A subsequent event may correspond to a report, and change or alter information presented in a report. For instance, in response to the determination of validity of the previous event, the report may omit analysis on the validity of the patent.

The second report 2513 may relate to the first report 2507 by way of a report reference 2517. The report reference 2517 may consist of data or information that is shared within the same legal dispute or from one report to another. Non-limiting examples of information in the report reference 2517 may be party names, party representation, phone numbers, addresses, previous events, patent numbers, other patent information, documents, dates, and other data pertaining to the legal dispute 2501. The report reference information 2517 may also include information that has been calculated, put into context, analyzed or some combination thereof such as section determinations items 611, 613 of FIG. 6, determinations 703 of FIG. 7, contribution scores 707 of FIG. 7, final determinations 1007, 1009 of FIG. 10, or other information. The report references 2517 may be passed to an analysis system such as described in relation to FIG. 14 when calculating a related or subsequent report type such as second report 2513 and/or Nth report 2519. Additionally or alternatively, the event relations information 2511 may be included in the event reference 2517.

The Nth report type 2519 may relate to an Nth event 2515 in the same manner as the first event 2503 relates to the first report type 2507. Multiple events can relate to and reference multiple previous events.

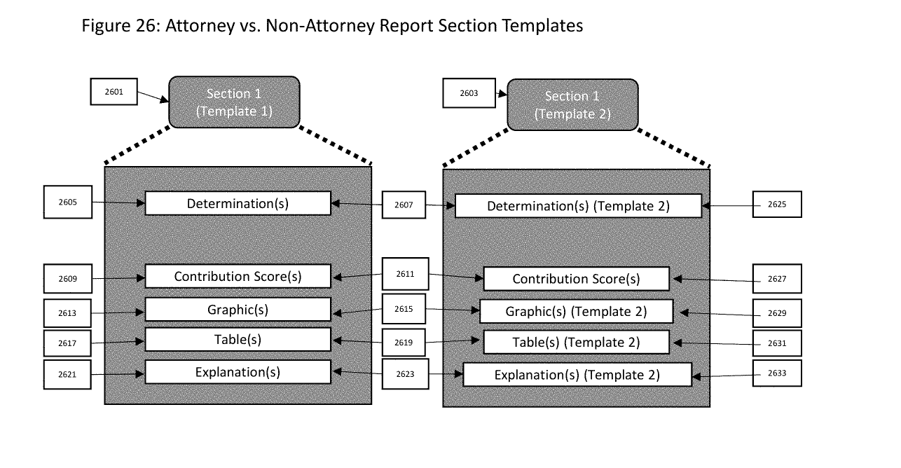

FIG. 26 illustrates two section templates which may be intended for different audiences. A first forecast report section may be generated from a first section template 2601 corresponding to section 701 of FIG. 7. A second forecast report section may be generated from a second section template 2603. For illustrative purposes, it is contemplated that the first section template 2601 is intended for a non-attorney audience, while the second section template 2603 is intended for an attorney audience. Also contemplated are additional forecast report section templates appropriate for a variety of audiences including but not limited to investors and financiers.

The second section template 2603 may differ from the first section template 2601 in the ways outlined below.

The first section template 2601 contains a determination 2605 which corresponds to determination 703 of FIG. 7. The second section template 2603 contains a second determination 2625. Differences between the determination 2605 and the second determination 2625 can be outlined by a determination modification 2607. The determination modification 2607 may include alterations in the labelling of different potential determinations. In one illustrative example, an attorney may understand the term “litigious” whereas a non-attorney may not. In the second determination 2625, “litigious” may exist on a range of possible determinations whereas the terminology for a non-attorney available for inclusion in the determination 2605 may replace “litigious” with a term such as “aggressive.” The determination modification 2607 may include alterations to the number of, or calculation of, potential determinations.

The forecast report section 2601 contains a contribution score 2609 which corresponds to contribution score 707 of FIG. 7. The second section template 2603 contains a second contribution score 2627. Differences between the contribution score 2609 and the second contribution score 2627 can be altered by a contribution score modification 2611. The contribution score modification 2611 may mathematically alter the calculations of the contribution score based on a variety of factors.

The forecast report section 2601 contains a graphic 2613 which corresponds to graphic 711 of FIG. 7. The second section template 2603 contains a second graphic 2629. The differences between the graphic 2613 and the second graphic 2629 can be described by a graphic modification 2615. The graphic modification 2615 may include differences in graphic labelling and/or levels of graphic detail. For example, in a section analyzing court venue results, an attorney may be interested in the number of cases which were subject to an inter-district transfer whereas a non-attorney may not understand this term and may be confused by its inclusion. In the graphic 2613, certain graphic details may be combined and/or relabeled so as to make a graphic more accessible to a layperson. In the example of the section analyzing court venue results, complicated or confusing results such as transfers, consolidations, and unresolved cases may be lumped together and labeled “other” for simplicity, as a layperson may not understand or want to know about these results. However, the corresponding graphic 2629 may not lump these results together and may instead display them individually within the graphic.

The forecast report section 2601 contains a table 2617 which corresponds to table 713 of FIG. 7. The second section template 2603 contains a second table 2631. The differences between the table 2617 and the second table 2631 can be described by a table modification 2619. The table modification 2619 may include differences in the text included in explanations, notes, labels, element fields and the like. For example, a section in the forecast report section 2601 analyzing court venues may include a table 2617 containing a “case result” column with three possible results: “Plaintiff Win”, “Defendant Win”, and “Likely Settlement”. A corresponding second table 2631 included in the second section template 2603 may contain more possible results such “Plaintiff Win: Summary Judgement” and “Plaintiff Win: Trial” which are counted together in the result “Plaintiff Win” in the corresponding table 2617. In this way, an attorney may be presented with a more detailed and technical analysis than a non-attorney.

The forecast report section 2601 contains an explanation 2621 which corresponds to explanation 713 of FIG. 7. The second section template 2603 contains a second explanation 2633. The differences between the explanation 2621 and the second explanation 2633 can be altered by an explanation modification 2623. The explanation modification 2623 may include substantial differences in the content of an explanation. For example, the second explanation 2633 may use more legal jargon, while the first explanation 2621 may contain analogies that relate legal ideas to real-world examples which are easier for a layperson to comprehend.

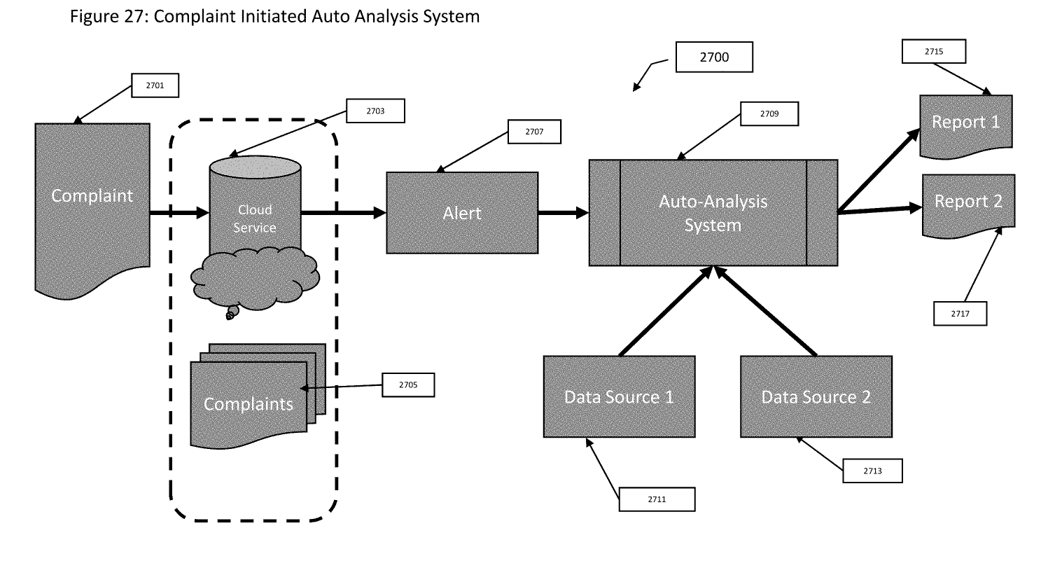

FIG. 27 illustrates an example system 2700 for generating reports in response to a complaint filing. The system 2700 may perform functionality similar to the system 2300 illustrated in FIG. 23 with a complaint 2701, a cloud service 2703, complaints 2705, alert 2707 functionally corresponding to items 2301, 2309, 2305, and 2311 from FIG. 23, respectively. An auto-analysis system 2709 may be configured to receive an alert 2707 from a cloud service 2703. The auto-analysis system 2709 may receive information about a complaint, or an actual manifestation of a complaint 2701, from the cloud service 2703 via an alert 2707. In response to receiving the alert 2707, the auto-analysis system 2709 may request or access data from a first data source 2711, a second data source 2713, and/or other data sources. The auto-analysis system 2709 may also request or access additional data from the cloud service 2703 not contained in the alert 2707. The auto-analysis system 2709 may perform analysis and calculations to generate sections such as those described in predefined process 805 of FIG. 8; perform combination processing 1209 and 1217 described in relation to FIG. 12; utilize templates 1423, data sources 1425 and 1427, internal data sources 1429, and the presentation module 1419 such as described in relation to FIG. 14; and/or analyze, process, generate, store, and/or review a report as described in the example procedure of FIG. 17. The auto analysis system 2709 may produce a first report 2715, which may be distinct from a second report 2717, or additional reports.

FIG. 28 illustrates an example procedure 2800 for generating reports from templates specific to user types parties of interest, and event types.

A type of user 2801 is determined. This may be accomplished via a user interface prompting a user to identify as a member of one of the selectable categories. Alternatively or additionally, a user's information may be saved in a data store which may contain a preconfigured type of user category. Also contemplated is a type of user category selected by an analyst or analysis system. For example, an analysis system may be configured to automatically generate reports by a computing device in response to a complaint or other filing. In this example, a type of user 2801 may need to be selected or inferred prior to contact with the user, or to generate a report relating to the user. An analysis system or analyst may refer to a database containing user types and corresponding names to determine the type of user 2801. Additionally or alternatively, an analysis system or analyst may utilize contextual information to determine the type of user 2801. For example, if the name of a user is substantially similar to the name of a party involved in a lawsuit, then the analysis system or analyst may infer that the particular user is a specific type of user. Similarly, the names of attorneys are often present in court documents. If a user name is substantially similar to an attorney of record in a lawsuit then the analyst or system may be able to infer the type of user 2801 for that user. Other methods of inference are also contemplated including, but not limited to naming conventions (such as “PLLC” following a law firm name or “Esquire” following a lawyer's name) and other heuristics.

The type of user 2801 may include a third party user type 2803. The third party user type 2803 may relate to investors to a party in litigation who may be concerned about how litigation may affect the value of their investment. The third party user type 2803 may also refer to any other party interested in analysis of a particular litigation or dispute.

An attorney user type 2805 may relate to an attorney interested in a lawsuit. This may or may not relate to an attorney representing one of the parties to litigation.

A party user type 2807 may relate to a party to litigation such as a plaintiff or defendant.

A party type of interest 2809 is determined. The party type of interest 2809 may be determined in a similar fashion to the type of user 2801 such as, but not limited to, prompting the user to provide the information, or by inferring the party type of interest 2809 via available information. The party type of interest 2809 can be used to determine one or more subjects of an analysis report. For example, a defendant to litigation may be interested in a report containing analysis about the plaintiff to litigation in that particular lawsuit. The defendant may then request a report where the plaintiff is the party type of interest 2809. Additionally or alternatively, the defendant to litigation may be interested in analysis of themselves in that particular lawsuit. In this case, the defendant may then request a report where the defendant is the party type of interest 2809. The party type of interest 2809 will determine, at least in part, the data and information included in a report. In one illustrative example, if the party type of interest 2809 is “plaintiff” then the resulting report will include information about a particular entity's record in litigation in the plaintiff role and may not provide information for that entity's record in litigation in the defendant role.

The party type of interest 2809 may result in a defendant party type 2811. The defendant party type 2811 corresponds to a defendant, or recipient of a lawsuit. The defendant party type 2811 may also correspond to the accused party or potential infringer if litigation has not been initiated. The defendant party type 2811 may include one or more entities, such as in the case where a single litigation has multiple defendants.

The party type of interest 2809 may result in a plaintiff party type 2813. The plaintiff party type 2813 corresponds to a plaintiff or initiator of a lawsuit. The plaintiff party type 2813 may also correspond to the accusing party or patent owner (or other type of intellectual property such as a trademark, trade secret, copyright or other form of intellectual property) or licensor, if litigation has not been initiated. The plaintiff party type 2813 may include one or more entities, such as in the case where a single litigation has multiple plaintiffs.

The party type of interest 2809 may result in multiple party types 2815. The multiple party types 2815 may include both plaintiffs and defendants. If litigation has not been initiated, the multiple party types 2815 may include the accusing, as well as the accused parties.

An event type 2817 is determined. The event type 2817 corresponds to, and includes but is not limited to, event types described in relation to FIG. 20, such as the complaint 2001.

An analysis system 2819 is contemplated. The analysis system 2819 may incorporate the auto-analysis system 809 of FIG. 8. The analysis system 2819 may also receive the type of user 2801 selection, the party type of interest 2809 selection, and the event type 2817. The analysis system 2819 may also access information from one or more data sources as described in relation to the auto-analysis system 809, the first data source 811, and the second data source 813 of FIG. 8.

The analysis system 2819 may incorporate or have access to a template store 2821. The template store 2821 may contain one or more templates for generating forecast reports. Different templates may correspond to the user types 2801, the party types of interest 2809, the event types 2817 and combinations thereof. For example, a first template may correspond to the attorney user type 2805, the defendant party type of interest 2811, and the complaint event type 2817. In an alternative example, a second template may correspond to the party user type 2807, the plaintiff party type of interest 2813, and the complaint event type 2817. Templates may differ in the number, order, and composition of sections as described in relation to FIG. 24, as well as within sections as described in relation to FIG. 26. The analysis system then 2819 may generate one or more reports 2823, using a selected template in the manner described in relation to the internal system 1401 of FIG. 14 and/or the procedure 1700 of FIG. 17.

Having considered examples of different forecasting reports, consider now possible implementations of processes for generating and outputting forecasting reports.

### Example Procedures for Generating and Outputting Forecasting Reports

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-28.

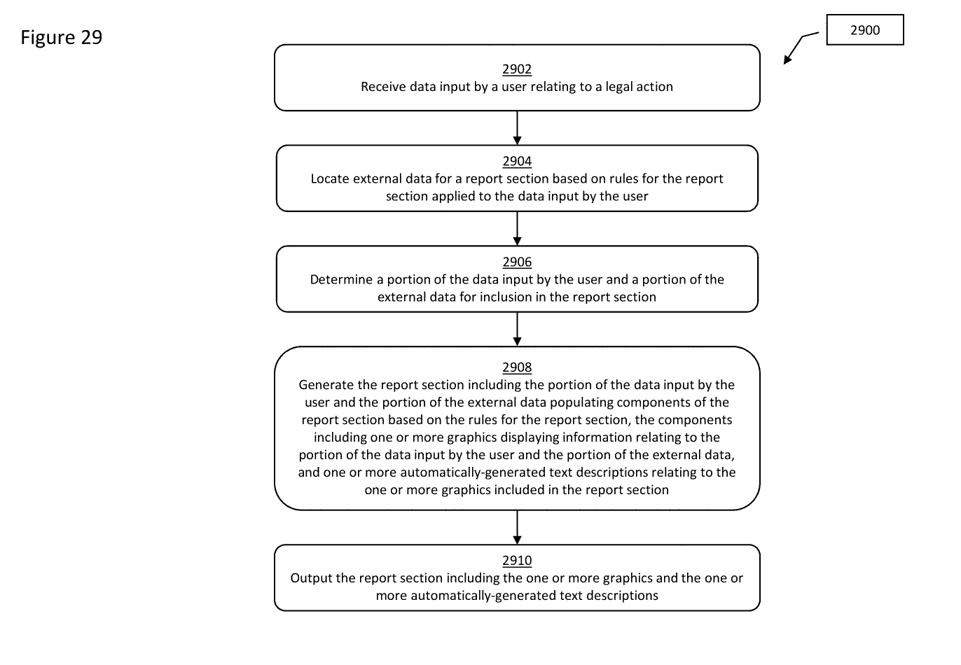

FIG. 29 depicts a procedure 2900 in an example implementation in which documents relating to a legal action are evaluated. First, data input by a user relating to a legal action is received (block 2902). The data input by the user may be a demand letter or complaint uploaded, such as by using the demand letter upload 201 of FIG. 2. Alternatively or additionally, the data input by the user may be in an application or user interface that prompts the user for different pieces of information, such as the client data 203 and/or the input data 205 of FIG. 2.

External data for a report section is located based on rules for the report section applied to the data input by the user (block 2904). For example, the analysis module 1415 may use the data input by the user to locate additional information located in external data sources 1425 and 1427 (and/or internal data sources, such as internal data source 1429). In doing so, the analysis module 1415 may generate search queries using the data input by the user and access the external data in the databases using the generated search queries. In some examples, the external data accessed from an external database may be used to generate an additional search query for accessing additional external data in the external database or in another external (or internal) database.

Next, a portion of the data input by the user and a portion of the external data are determined for inclusion in the report section (block 2906). For instance, the predefined process 805 extracts the address from a demand letter for the Court Assessment section, and query a data source to find the closest proximal court venue. Once the closest proximal court venue is retrieved, the predefined process 805 for the Court Assessment section queries a second data source to ascertain the record of plaintiff wins and defendant wins for that court venue. The analysis module 1415 and/or the presentation module 1419 may then determine that the address, the closest proximal court venue, and the record of plaintiff wins and defendant wins are to be included in the Court Assessment report section, as described above.

The report section is generated, including the portion of the data input by the user and the portion of the external data populating components of the report section based on rules for the report section (block 2908). The components include one or more graphics displaying information relating to the portion of the data input by the user and the portion of the external data. For example, a graphic may include a visual comparison between the portion of the data input by the user and the portion of the external data, such as the law firm comparison depicted in the graphic 605. The components also include one or more automatically-generated text descriptions relating to the one or more graphics included in the report section. For instance, the automatically-generated text descriptions may comprise a natural language description describing one or more of a context for a determination included in the report section, a methodology for the determination included in the report section, a result of the determination included in the report section, and/or an implication of the determination included in the report section. Generating the report section may further include generating a determination based on a function of the portion of the data input by the user and the portion of the external data, as described in relation to the first determination 611. The determination may then be used to generate a contribution score based on the determination, where the contribution score combines multiple contribution scores from multiple sections of the report for an overall composite score for the report, such as described in relation to the contribution score 707.

The report section is then output including the one or more graphics and the one or more automatically-generated text descriptions (block 2910). The report section may be output as part of a report that includes multiple sections relating to the legal action, such as by way of the report type combination processing 1209 and/or 1217. The report section may be output in a user interface, such as in a web browser or part of an application interface, as described above.

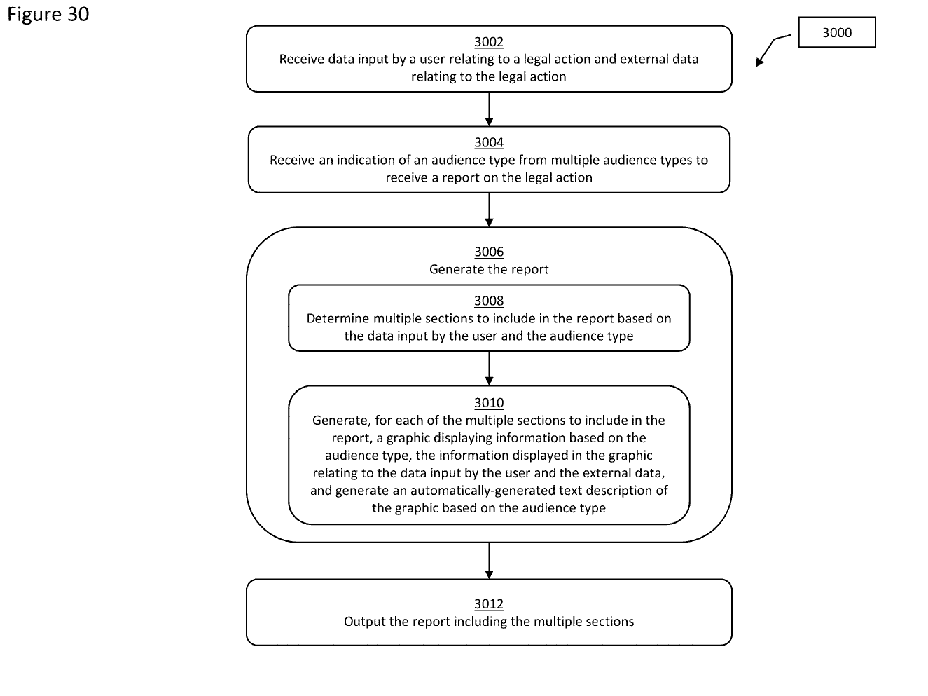

FIG. 30 depicts a procedure 3000 in an example implementation in which documents relating to a legal action are evaluated for an audience type. First, data input by a user relating to a legal action, and external data relating to the legal action, are received (block 3002). The data input by the user may be received according to step 2902 of FIG. 29. The data input by the user may comprise a demand letter or complaint uploaded via a user interface or application, as described above. The external data may be received by executing search queries as described in relation to step 2904 of FIG. 29, for example.

Next, an indication of an audience type from multiple audience types is received to receive the report on the legal action (block 3004). Example audience types may include a layperson (or general audience), an attorney, a plaintiff, a defendant, or another party to a litigation, as described above.

The report is generated (block 3006). To generate the report, multiple sections are determined for inclusion in the report based on the data input by the user and the audience type (block 3008). For instance, the data input by the user may not provide sufficient information to include a particular section of a report, and therefore the section of the report may be omitted. Different sections may be included in a report for an attorney audience versus a non-attorney audience, and/or different sections may be included in a report for a plaintiff audience versus a defendant audience, to name a few examples. Determining which sections to include in the report may further include determining an order of the sections included in the report based on the data input by the user, such as whether the data input by the user is a demand letter or a complaint.

For each of the multiple sections to be included in the report, a graphic displaying information based on the audience type is generated, and an automatically-generated text description is generated (block 3010). The information displayed in the graphic relates to the data input by the user and the external data. For example, a graphic may include a visual comparison between the portion of the data input by the user and the portion of the external data, such as the law firm comparison depicted in the graphic 605, as described above. A level of detail to include in the graphic may be determined based on the audience type. The automatically-generated text description describes the graphic based on the audience type. For instance, different language may be used based on whether the report is intended for an attorney audience versus a non-attorney audience, and/or whether the report is intended for a plaintiff audience versus a defendant audience, to name a few examples. The report, including the multiple sections, is then output (block 3012), such as using techniques described above.

### Example System and Device

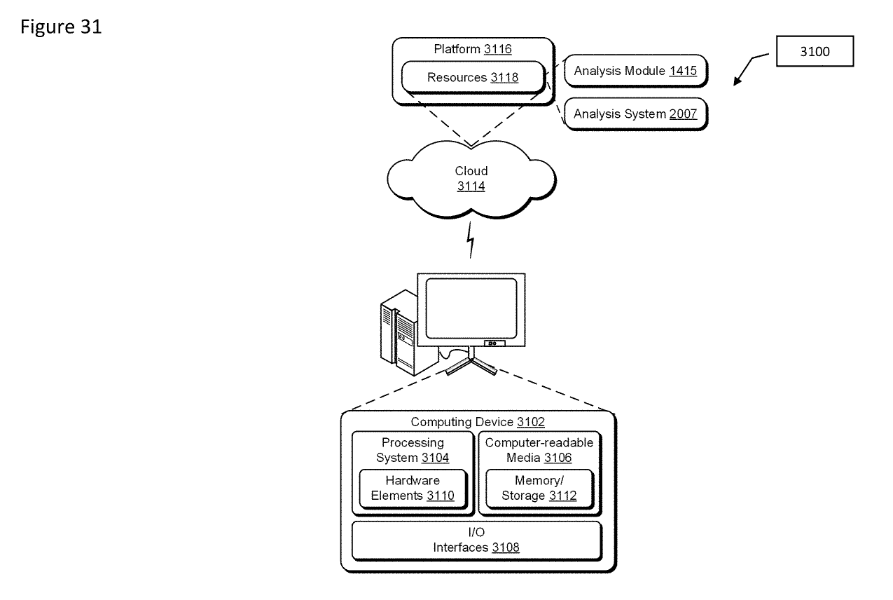

FIG. 31 illustrates an example system generally at 3100 that includes an example computing device 3102 that is representative of one or more computing systems and/or devices that may implement the various techniques described herein. This is illustrated through inclusion of the analysis module 1415 and the analysis system 2007. The computing device 3102 may be, for example, a server of a service provider, a device associated with a client (e.g., a client device), an on-chip system, and/or any other suitable computing device or computing system.

The example computing device 3102 as illustrated includes a processing system 3104, one or more computer-readable media 3106, and one or more I/O interface 3108 that are communicatively coupled, one to another. Although not shown, the computing device 3102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 3104 is representative of functionality to perform one or more operations using hardware. Accordingly, the processing system 3104 is illustrated as including hardware element 3110 that may be configured as processors, functional blocks, and so forth. This may include implementation in hardware as an application specific integrated circuit or other logic device formed using one or more semiconductors. The hardware elements 3110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 3106 is illustrated as including memory/storage 3112. The memory/storage 3112 represents memory/storage capacity associated with one or more computer-readable media. The memory/storage component 3112 may include volatile media (such as random access memory (RAM)) and/or nonvolatile media (such as read only memory (ROM), Flash memory, optical disks, magnetic disks, and so forth). The memory/storage component 3112 may include fixed media (e.g., RAM, ROM, a fixed hard drive, and so on) as well as removable media (e.g., Flash memory, a removable hard drive, an optical disc, and so forth). The computer-readable media 3106 may be configured in a variety of other ways as further described below.

Input/output interface(s) 3108 are representative of functionality to allow a user to enter commands and information to computing device 3102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 3102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 3102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 3102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 3110 and computer-readable media 3106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 3110. The computing device 3102 may be configured to implement particular instructions and/or functions corresponding to the software and/or hardware modules. Accordingly, implementation of a module that is executable by the computing device 3102 as software may be achieved at least partially in hardware, e.g., through use of computer-readable storage media and/or hardware elements 3110 of the processing system 3104. The instructions and/or functions may be executable/operable by one or more articles of manufacture (for example, one or more computing devices 3102 and/or processing systems 3104) to implement techniques, modules, and examples described herein.

The techniques described herein may be supported by various configurations of the computing device 3102 and are not limited to the specific examples of the techniques described herein. This functionality may also be implemented all or in part through use of a distributed system, such as over a “cloud” 3114 via a platform 3116 as described below.

The cloud 3114 includes and/or is representative of a platform 3116 for resources 3118. The platform 3116 abstracts underlying functionality of hardware (e.g., servers) and software resources of the cloud 3114. The resources 3118 may include applications and/or data that can be utilized while computer processing is executed on servers that are remote from the computing device 3102. Resources 3118 can also include services provided over the Internet and/or through a subscriber network, such as a cellular or Wi-Fi network.

The platform 3116 may abstract resources and functions to connect the computing device 3102 with other computing devices. The platform 3116 may also serve to abstract scaling of resources to provide a corresponding level of scale to encountered demand for the resources 3118 that are implemented via the platform 3116. Accordingly, in an interconnected device embodiment, implementation of functionality described herein may be distributed throughout the system 3100. For example, the functionality may be implemented in part on the computing device 3102 as well as via the platform 3116 that abstracts the functionality of the cloud 3114.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method, comprising:
receiving, by at least one computing device, data input by a user relating to a legal action;
locating, by the at least one computing device, external data for a report section based on rules for the report section applied to the data input by the user;
determining, by the at least one computing device, a portion of the data input by the user and a portion of the external data for inclusion in the report section;
generating, by the at least one computing device, the report section including the portion of the data input by the user and the portion of the external data populating components of the report section based on the rules for the report section, the components including:
one or more graphics displaying information relating to the portion of the data input by the user and the portion of the external data; and
one or more automatically-generated text descriptions relating to the one or more graphics included in the report section; and
outputting, by the at least one computing device, the report section including the one or more graphics and the one or more automatically-generated text descriptions.

2. The computer-implemented method of claim 1, wherein the data input by the user comprises a demand letter or a complaint, and wherein the determining the portion of the data input by the user for inclusion in the report section comprises extracting the portion of the data input by the user from the demand letter or the complaint.

3. The computer-implemented method of claim 1, wherein the one or more automatically-generated text descriptions comprise a natural language description describing one or more of:
a context for a determination included in the report section;
a methodology for the determination included in the report section;
a result of the determination included in the report section; or
an implication of the determination included in the report section.

4. The computer-implemented method of claim 1, wherein the one or more graphics include a visual comparison between the portion of the data input by the user and the portion of the external data.

5. The computer-implemented method of claim 1, wherein the generating of the report section further comprises generating a determination based on a function of the portion of the data input by the user and the portion of the external data.

6. The computer-implemented method of claim 5, wherein the generating of the determination causes an indicator to populate information corresponding to the determination in the one or more automatically-generated text descriptions.

7. The computer-implemented method of claim 5, wherein the generating of the determination includes:
comparing a score value associated with the determination to a determination threshold; and
selecting the determination from a range of possible determinations based on said comparing.

8. The computer-implemented method of claim 5, further comprising:
generating a contribution score based on the determination; and
using the contribution score to calculate a composite score for the report, the composite score combining multiple contribution scores from multiple sections of the report.

9. The computer-implemented method of claim 1, wherein the report section is an object-oriented class containing properties and methods performed by the at least one computing device.

10. A system comprising:
one or more processors; and
one or more computer-readable storage media including instructions stored thereon that, responsive to execution by the at least one processor, cause the system perform operations including:
receiving, by at least one computing device, data input by a user relating to a legal action;
locating, by the at least one computing device, external data for a report section based on rules for the report section applied to the data input by the user;
determining, by the at least one computing device, a portion of the data input by the user and a portion of the external data for inclusion in the report section;
generating, by the at least one computing device, the report section including the portion of the data input by the user and the portion of the external data populating components of the report section based on the rules for the report section, the components including:
one or more graphics displaying information relating to the portion of the data input by the user and the portion of the external data; and
one or more automatically-generated text descriptions of the one or more graphics included in the report section; and
outputting, by the at least one computing device, the report section including the one or more graphics and the one or more automatically-generated text descriptions.

11. The system of claim 10, wherein the locating the external data comprises:
generating search queries for two or more databases; and
accessing the external data in the two or more databases using the search queries.

12. The system of claim 11, wherein the external data accessed from one of the two or more databases is used to generate an additional search query for accessing additional external data in another of the two or more databases or in a third database.

13. The system of claim 10, wherein the generating the report section further comprises generating a determination based on a function of the portion of the data input by the user and the portion of the external data.

14. The system of claim 13, wherein the generating the report section further comprises displaying the determination and one or more of the components in the report section in a color selected from multiple colors associated with the determination.

15. The system of claim 10, wherein the one or more graphics includes an indicator of a relative importance of the portion of the data input by the user, or an impact on a determination included in the report section by the portion of the data input by the user.

16. A method, comprising:
receiving, by at least one computing device, data input by a user relating to a legal action and external data relating to the legal action;
receiving, by the at least one computing device, an indication of an audience type from multiple audience types to receive a report on the legal action;
generating, by the at least one computing device, the report, the generating including:
determining multiple sections to include in the report based on the data input by the user and the audience type; and
generating, for each of the multiple sections to include in the report:
a graphic displaying information based on the audience type, the information displayed in the graphic relating to the data input by the user and the external data; and
an automatically-generated text description of the graphic based on the audience type; and
outputting, by the at least one computing device, the report including the multiple sections.

17. The method of claim 16, wherein the data input by the user comprises either a demand letter or a complaint, and wherein the automatically-generated text description changes based on whether the data input by the user comprises the demand letter or the complaint.

18. The method of claim 16, wherein the data input by the user comprises either a demand letter or a complaint, and wherein the generating the report further comprises ordering the multiple sections based on whether the data input by the user comprises the demand letter or the complaint.

19. The method of claim 16, further comprising:
receiving an indication of an event subsequent to the legal event;
generating an additional report, the additional report including information relating to effects of the subsequent event on the legal action.

20. The method of claim 16, wherein the generating the graphic includes determining a level of detail to include in the graphic based on the audience type.
